(19) United States
(12) Patent Application Publication
(10) Pub. No.: US 2026/0054503 A1
(43) Pub. Date: Feb. 26, 2026

(54) LASER MARKING APPARATUS

(71) Applicant: Keyence Corporation, Osaka (JP)

(72) Inventor: Junya ONODA, Osaka (JP)

(73) Assignee: Keyence Corporation, Osaka (JP)

(21) Appl. No.: 19/266,230

(22) Filed: Jul. 11, 2025

(30) Foreign Application Priority Data
Aug. 23, 2024 (JP) 2024-141854

(51) Int. Cl. B41J 2/44; B41J 3/46; B41J 11/00; B41J 29/00; G06K 15/00; G06K 15/02; G06K 15/12; G06T 7/00

(52) U.S. Cl. CPC B41J 2/442; B41J 3/46; B41J 11/0095; B41J 29/00; G06K 15/007; G06K 15/1204; G06K 15/1882; G06T 7/0004; G06T 2207/30144; G06T 2207/30164

(57) ABSTRACT

The laser marking apparatus L includes a printing controller 100 that executes a printing process to form a predetermined printing pattern Pm within a printing area R1, and pre-post printing processes performed before and after the printing process; a storage unit 303 that stores order information Io; a workflow editor 304c that edits a workflow Wf defining a series of processes including the printing process; and an input receiver 304g that accepts selection of pre-post printing processes to be included in the workflow Wf according to user input from the pre-post printing processes. The workflow editor 304c adds the pre-post printing processes, for which selection has been accepted by the input receiver 304g, to the workflow Wf in an order according to the order information Io. The printing controller 100 executes the printing process and the pre-post printing processes in the order defined by the edited workflow Wf.

### CROSS-REFERENCE TO RELATED APPLICATIONS

The present application claims foreign priority based on Japanese Patent Application No. 2024-141854, filed Aug. 23, 2024, the contents of which are incorporated herein by reference.

### BACKGROUND OF THE INVENTION

### 1. Technical Field

This disclosure relates to a laser marking apparatus.

### 2. Description of the Related Art

For example, JP 2012-143785 A discloses a laser processing system equipped with a laser marker as a laser marking apparatus. Specifically, the laser processing system disclosed in this JP 2012-143785 A is equipped with a camera that captures an imaging area narrower than the processing area, which consists of a region where laser light can be irradiated. This camera has an imaging optical axis (light receiving axis) branched from the laser optical axis (emission axis of laser light) and captures a specified imaging position within the processing area.

Furthermore, the laser processing system related to the aforementioned JP 2012-143785 A is configured to calculate the error in the position and orientation of the workpiece based on the captured image taken within the processing area.

On the other hand, JP 2020-104156 A discloses a laser marker as an example of a laser processing apparatus. Specifically, the laser marker disclosed in this JP 2020-104156 A is equipped with a distance measuring light emitting unit that emits distance measuring light, a light receiving element that receives the distance measuring light reflected by the workpiece (object to be processed), and a distance measuring unit that measures the distance from the laser marker to the surface of the workpiece (object to be processed) based on the light receiving position of the distance measuring light on the light receiving element.

Meanwhile, as described in the aforementioned JP 2020-104156 A and JP 2012-143785 A, it is possible to calculate errors in the position and orientation of the workpiece, or measure the distance to the surface of the workpiece, before and after irradiating the workpiece with laser light.

These calculations and measurements can be utilized for various processes before and after the marking process (hereinafter referred to as “printing process”) when performing various markings with laser light.

When performing multiple types of such processes, it would be convenient to set the execution order of each process and execute them according to that setting. However, conventionally, it has been considered necessary to set the execution order appropriately based on understanding the role of each process. This requires users to have knowledge about the roles of each process, which is inconvenient from the viewpoint of user convenience.

Furthermore, even if the user has knowledge about each process, setting the execution order considering that knowledge requires effort, which is still inconvenient from the viewpoint of user convenience.

### SUMMARY OF THE INVENTION

This disclosure is made in view of such points, and its purpose is to improve user convenience of the laser marking apparatus.

The first aspect of this disclosure relates to a laser marking apparatus. This laser marking apparatus comprises a laser light generator that generates laser light to be irradiated onto a printing area of a workpiece, a laser light scanner that two-dimensionally scans the laser light generated by the laser light generator within the printing area, an imaging unit that captures an image of the workpiece to obtain a captured image, a distance detector that outputs a detection signal indicating the distance to a distance measurement position indicating a position for measuring the distance on the surface of the workpiece, and a controller. The controller executes a printing process to form a predetermined printing pattern within the printing area by controlling the laser light generator and the laser light scanner, and executes a pre-post printing process consisting of at least one of: a pre-printing process that controls at least one of the imaging unit and the distance detector to acquire information related to at least one of the position and orientation of the workpiece before executing the printing process, and a post-printing process that controls at least one of the imaging unit and the distance detector to acquire information related to the printing pattern formed by the printing process after executing the printing process.

According to the first aspect, the laser marking apparatus further includes an order information storage unit that stores order information associated with each of the pre-post printing processes, a trigger signal receiver that accepts input of a trigger signal for causing the controller to execute the printing process, a workflow editor that edits a workflow defining a series of processes including the printing process executed by the controller from when the trigger signal is input to the trigger signal receiver until it becomes possible to accept input of another trigger signal, a display unit that displays the pre-post printing processes associated with and stored in the order information storage unit corresponding to the order information, and an input receiver that accepts selection of the pre-post printing processes to be included in the workflow in response to user input from the pre-post printing processes displayed on the display unit. The workflow editor adds the pre-post printing processes, for which selection has been accepted by the input receiver, to the workflow including the printing process in an order corresponding to the order information stored in the order information storage unit and associated with the pre-post printing processes. The controller executes the printing process and the pre-post printing processes according to the order defined by the workflow to which the pre-post printing processes have been added by the workflow editor.

According to the first aspect, the workflow editor edits a workflow that defines a series of processes including the printing process based on user input. During this editing, the workflow editor adds the pre-post printing process, for which selection has been accepted by the input receiver, to the workflow in an order according to the order information stored in advance.

By configuring in this way, it becomes possible to appropriately set a workflow that defines the execution order of each process without requiring knowledge about the roles of each process, and to execute each process according to that setting. Moreover, even for users who have knowledge about the roles of each process, it becomes possible to quickly set the workflow without making judgments based on such knowledge sequentially. Therefore, the configuration related to the first aspect can improve the user convenience of the laser marking apparatus.

According to the second aspect of this disclosure, the distance detector may detect the light receiving position of the distance measuring light that is emitted toward the distance measurement position through the laser light scanner and reflected at the distance measurement position, and output a detection signal indicating the distance to the distance measurement position based on the light receiving position.

According to the second aspect, by configuring to emit the distance measuring light through the laser light scanner, the irradiation position of the distance measuring light can be changed with high accuracy. This is advantageous in improving the user convenience of the laser marking apparatus.

According to the third aspect of this disclosure, the display unit displays a setting surface corresponding to the printing area and displays the captured image generated by the imaging unit on the setting surface. The laser marking apparatus further includes a marking setting unit that sets the position and orientation of the marking pattern to be printed on the workpiece on the setting surface displayed on the display unit, a marking data generation unit that generates marking data corresponding to the marking pattern set by the marking setting unit, and a focal adjustment unit interposed between the laser light generator and the laser light scanner to adjust the focal position of the laser light generated by the laser light generator. The pre-printing process may include one or more of: a first pre-printing process that determines the position and orientation of the workpiece relative to the laser marking apparatus based on the captured image acquired through the imaging unit, and corrects the marking data so that the position and orientation of the marking pattern are adjusted according to the position and orientation of the workpiece based on the determination result; a second pre-printing process that determines the position and orientation of the workpiece relative to the laser marking apparatus based on the captured image acquired through the imaging unit, and decides the feasibility of the printing process on the workpiece based on the determination result; a third pre-printing process that adjusts the focal position through the focal adjustment unit based on the distance to the distance measurement position acquired through the distance detector; and a fourth pre-printing process that decides the feasibility of the printing process on the workpiece based on the distance to the distance measurement position acquired through the distance detector.

According to the third aspect, the pre-printing process related to this aspect may include numerous processes combining the imaging unit and the distance detector. Having the user themselves set the execution order of such processes is inconvenient from the viewpoint of user convenience.

The third aspect contributes to improving user convenience because it can execute each process in an appropriate order regardless of the user's knowledge, even in cases where numerous processes may be included in the pre-printing process.

According to the fourth aspect of this disclosure, when the input receiver accepts the selection of both the first and second pre-printing processes, the workflow editor may selectively add either one of the first and second pre-printing processes to the workflow.

The first pre-printing process and the second pre-printing process have many overlapping setting items and processes, and it is considered that there is virtually no situation where they are used in combination. While the first pre-printing process executes more advanced processes such as correction of printing data, it has setting items that require prior knowledge, making it not necessarily user-friendly for unfamiliar users. The second pre-printing process does not execute processes as advanced as the first pre-printing process, but it can be easily utilized even by unfamiliar users.

Therefore, the workflow editor according to the fourth aspect is configured to add only one of the processes that are not expected to be used in combination to the workflow. As a result, it becomes possible to create a more appropriate workflow.

Furthermore, according to the fifth aspect of this disclosure, when the input receiver accepts the selection of both the third and fourth pre-printing processes, the workflow editor may selectively add either one of the third and fourth pre-printing processes to the workflow.

The third pre-printing process and the fourth pre-printing process have many overlapping setting items and processes, and it is considered that there is virtually no situation where they are used in combination. The third pre-printing process executes more advanced processes such as correction of printing data, while it has setting items that require prior knowledge, making it not necessarily user-friendly for unfamiliar users. The fourth pre-printing process does not execute processes as advanced as the third pre-printing process, but it can be easily utilized even by unfamiliar users.

Therefore, the workflow editor according to the fifth aspect adds only one of the processes that are not expected to be used in combination to the workflow. As a result, it becomes possible to create a more appropriate workflow.

Furthermore, according to the sixth aspect of this disclosure, the order information may be defined such that the first or second pre-printing process is executed before the third or fourth pre-printing process.

According to the sixth aspect, the laser marking apparatus determines the position and orientation of the workpiece through the first or second pre-marking process, and then executes the third or fourth pre-marking process after the determination result. By executing each process in this order, it becomes possible to adjust the distance measurement position according to the position and orientation of the workpiece. This enables the use of a more appropriate distance measurement position.

Furthermore, according to the seventh aspect of this disclosure, when the workflow is defined such that the third pre-printing process is executed following the first pre-printing process, the controller may correct the distance measurement position based on the position and orientation of the workpiece determined by the first pre-printing process, and execute the third pre-printing process based on the corrected distance measurement position.

According to the seventh aspect, when configured to perform the third pre-printing process following the first pre-printing process, it becomes possible to correct the focal position based on the measurement results for the corrected distance measurement position, with the distance measurement position having been corrected utilizing the execution results of the first pre-printing process. This enables adjustment of the focal position after correcting the measurement position considering the position deviation of the workpiece, allowing for maintaining high printing accuracy even when the workpiece has deviated in position.

Setting a workflow that reflects such an order of processes is not necessarily easy. However, by configuring the system to automatically arrange the execution order according to the order information as in this embodiment, user convenience can be improved.

Furthermore, according to the eighth aspect of this disclosure, at least one of the pre-printing process and the post-printing process may further include a maintenance process for acquiring maintenance information of the laser marking apparatus by the controller controlling the distance detector, and the order information may be defined to include the execution order of the maintenance process.

The aforementioned maintenance process involves the control of the imaging unit and the distance detector. Therefore, it is believed that there exists an appropriate execution order for the first to fourth pre-printing processes. However, for unfamiliar users, setting the appropriate execution order is not easy.

In contrast, according to the eighth aspect, the order information is defined to include the execution order of maintenance processes. This enables the execution order of maintenance processes to be automatically defined when editing the workflow, contributing to improved user convenience.

According to the ninth aspect of this disclosure, the distance detector may comprise an emission unit that emits the distance measuring light toward the laser light scanner, and a light receiving unit that receives the distance measuring light emitted from the emission unit and reflected by the workpiece through the laser light scanner. The laser marking apparatus may include a housing in which the laser light generator and the laser light scanner are incorporated, a transparent member provided on the housing through which the laser light two-dimensionally scanned by the laser light scanner passes, and a window inspection unit that detects and outputs contamination of the transparent member as the maintenance information by identifying the distance measuring light caused by reflection from the transparent member among the distance measuring light received by the light receiving unit. The pre-printing process may include the maintenance process, and the order information may be defined such that the maintenance process is executed before the first to fourth pre-printing processes.

According to the ninth aspect, when the laser marking apparatus marks on a workpiece, the laser light emitted from the laser light generator is irradiated onto the workpiece through the laser light scanner and the transparent member. By scanning the laser light irradiated onto the workpiece, marking can be performed on this workpiece.

In this case, when contamination adheres to the transparent member, the light receiving part, which should originally receive only the distance measuring light reflected by the workpiece, receives the distance measuring light reflected by the transparent member instead of, or in addition to, this distance measuring light.

Here, the distance to the transparent member does not vary regardless of the type of workpiece. Therefore, the light receiving position caused by contamination on the transparent member can be estimated in advance.

Therefore, for example, by considering the location of each light receiving position, the window inspection unit can identify the distance measuring light caused by the reflected light from the transparent member among the distance measuring light received by the distance measuring light receiving unit. Thereby, the window inspection unit becomes capable of detecting contamination on the transparent member.

Contamination of the transparent member is inconvenient for processes that require the passage of distance measuring light, imaging light, etc., through the transparent member, such as the first to fourth pre-printing processes. Therefore, by configuring the system to perform maintenance processing before the first to fourth pre-printing processes, it becomes possible to stop the operation of the laser marking apparatus early when abnormalities or signs of abnormalities are observed in the maintenance information. This advantageously contributes to improving user convenience.

According to the tenth aspect of this disclosure, the post-printing process may include an inspection process that inspects the workpiece on which the printing pattern has been printed by the printing process, based on the captured image acquired through the imaging unit, and the order information may be defined such that the maintenance process is executed after the inspection process.

Since the maintenance process corresponds to a process for inspecting the state of the laser marking apparatus itself, it can be performed smoothly even when the workpiece after printing is in a state separated from the laser marking apparatus. On the other hand, the inspection process requires imaging of the workpiece, so it can no longer be performed if the workpiece after printing has moved away from the laser marking apparatus. Therefore, it is convenient to perform the maintenance process after the inspection process.

On the other hand, for users unfamiliar with maintenance processes, it is not necessarily easy to configure the system to perform maintenance processes after inspection processes.

In contrast, by defining the order information so that the maintenance process is executed after the inspection process as in the tenth aspect, even an inexperienced user can construct a more appropriate workflow. This advantageously improves user convenience.

Furthermore, according to the 11th aspect of this disclosure, the display unit may display a flow display area that visualizes the structure of the workflow reflecting the execution order of the pre-post printing processes relative to the printing process, and a flow selection area that is displayed independently from the flow display area, lists the pre-post printing processes, and accepts user input for selecting the pre-post printing processes.

According to the eleventh aspect, the display unit displays a flow display area and a flow selection area independently. This configuration contributes to improving user convenience.

Furthermore, according to the twelfth aspect of this disclosure, the display unit may display a switching section for switching the execution possibility of each of the pre-post printing processes constituting the workflow in the workflow displayed in the flow display area. The input receiver may accept user input selecting the execution possibility through the switching section. The controller may execute the printing process and the pre-post printing process to reflect the user input through the switching section.

According to the twelfth aspect, each process constituting the workflow can be individually turned on and off without changing the structure of the workflow itself each time. This is advantageous in improving user convenience.

As described above, this disclosure can improve user convenience of the laser marking apparatus.

### BRIEF DESCRIPTION OF THE DRAWINGS

FIG. 1 is a diagram illustrating the overall configuration of a laser marking system.

FIG. 2 is a block diagram illustrating the schematic configuration of a laser marking apparatus.

FIG. 3 is a block diagram illustrating the details of a setting device.

FIG. 4 is a diagram illustrating the schematic configuration of a printing head.

FIG. 5 is a perspective view illustrating the appearance of the printing head.

FIG. 6 is a diagram explaining the distance measuring unit and the triangulation method.

FIG. 7 is a flowchart showing the usage procedure of the laser marking system.

FIG. 8 is a table displaying a list of the breakdown of pre-printing process, printing process, and post-printing process, the compatibility of each process, order information, and usage examples of each process.

FIG. 9 is a flowchart illustrating the processes related to print settings and workflow editing.

FIG. 10 is a diagram illustrating the relationship between the printing area and the setting surface.

FIG. 11 is a diagram illustrating the display content on the display unit.

FIG. 12 is a diagram for explaining pattern search.

FIG. 13 is a diagram for explaining tilt correction.

FIG. 14 is a diagram for explaining height detection.

FIG. 15 is a diagram for explaining window inspection.

FIG. 16 is a diagram for explaining the effect of contamination on the transparent member.

FIG. 17 is a flowchart illustrating the editing procedure of the workflow.

FIG. 18 is a diagram illustrating the editing screen of the workflow.

FIG. 19 is a diagram illustrating the editing screen of the workflow.

FIG. 20 is a diagram illustrating the editing screen of the workflow.

FIG. 21 is a diagram comparing the setting procedures for XYθ correction and image discrimination.

FIG. 22 is a diagram comparing the setting procedures for height correction and height detection.

FIG. 23 is a flowchart showing specific examples of pre-printing processes.

FIG. 24 is a flowchart showing specific examples of pre-printing processes.

FIG. 25 is a diagram for explaining trapezoidal correction.

FIG. 26 is a diagram explaining the relationship between workpiece position deviation and focal position.

### DETAILED DESCRIPTION

The following describes embodiments of this disclosure based on the drawings. It should be noted that the following description is exemplary.

In other words, although this specification explains about a laser marking apparatus, this disclosure can be applied to laser application equipment in general, such as “laser markers” and “laser processing apparatuses” that are capable of executing printing (laser marking) using laser light, regardless of the name “laser marking apparatus”.

Furthermore, in this specification, although character marking is explained as a representative example of printing, “printing” in this disclosure is not limited to character marking. The printing in this disclosure can be applied to “marking other than characters,” such as figure marking.

In addition, “marking other than characters” includes not only marking of figures such as “:” and “×”, but also marking of two-dimensional codes such as barcodes and QR codes (registered trademark). The term “figure” includes not only geometric figures such as “×”, but also arbitrary figures such as symbols. The shapes of characters and various figures to be marked are collectively referred to as “print pattern”hereinafter, and are assigned the code “Pm”.

In the following description, instead of the term “printing,” it may be referred to as “laser printing,” “marking,” “printing process,” or “processing.”

### 1. Overall Configuration

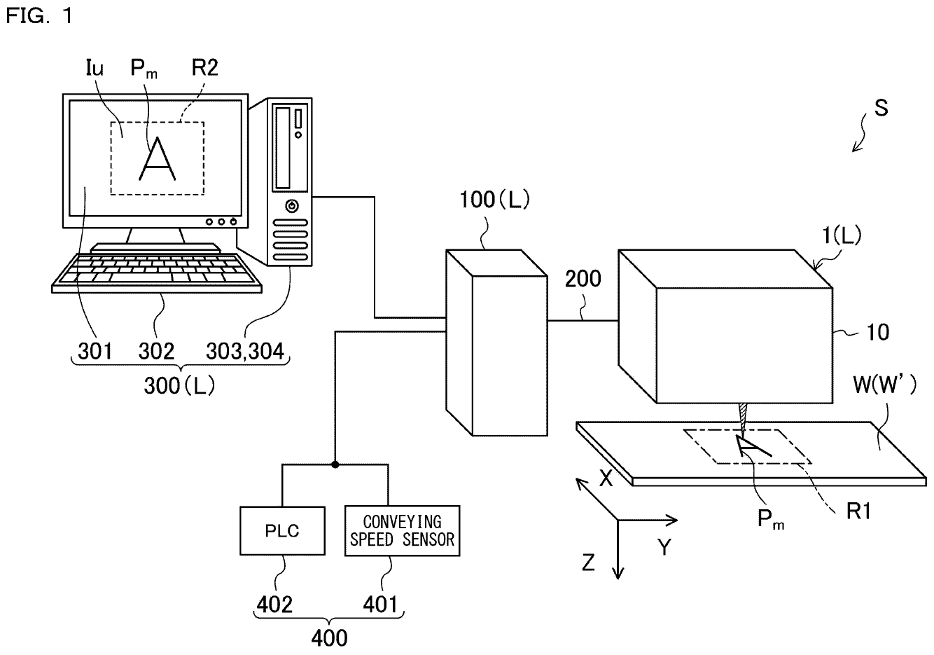

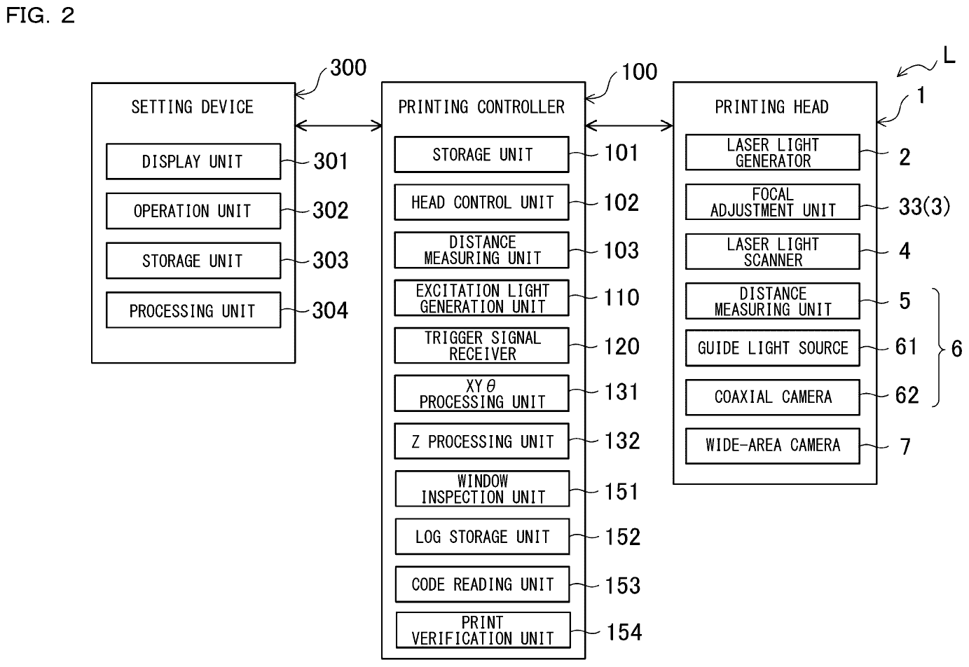

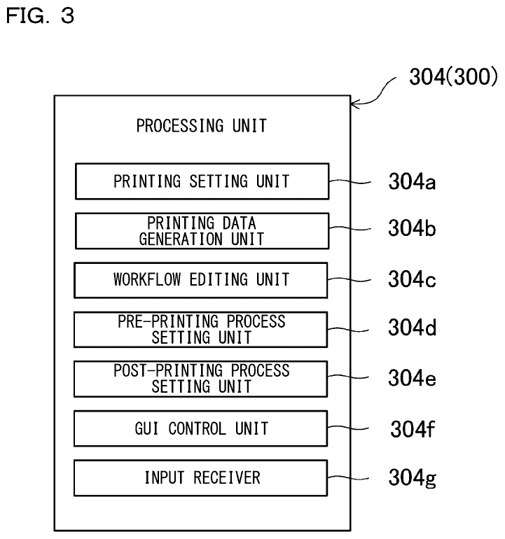

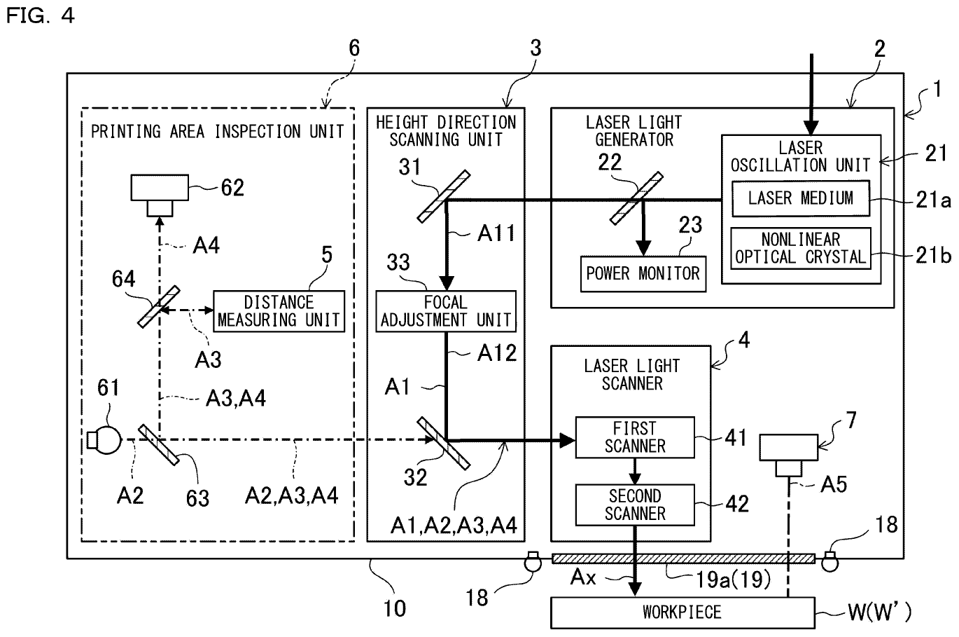

FIG. 1 is a figure illustrating the overall configuration of the laser marking system S, and FIG. 2 is a figure illustrating the schematic configuration of the laser marking apparatus L in the laser marking system S. FIG. 3 is a block diagram illustrating the details of the setting device 300. FIG. 4 is a figure illustrating the schematic configuration of the printing head 1.

As illustrated in FIG. 1, the laser marking system S comprises a laser marking apparatus L and an external device 400 connected to the laser marking apparatus L.

Among these, the laser marking apparatus L exemplified in FIG. 1 and FIG. 2 is configured to print a predetermined printing pattern Pm within the printing area R1 by controlling the later-described laser light generator 2 and laser light scanner 4.

The printing area R1 referred to here is, as shown in FIG. 1, an area set on the surface of the workpiece W as the object to be printed, and corresponds to the setting surface R2 in the same figure. For example, in FIG. 1, the printing area R1 is configured as a rectangular area. Also, the setting surface R2 referred to here corresponds to a virtual surface that can be displayed on the display unit 301 of the setting device 300. The setting surface R2 is used for various settings related to laser printing, as described later. The printing area R1 may be set to include the entire workpiece W, or it may be set to include only a part of the workpiece W.

The laser marking apparatus L performs marking by irradiating laser light generated in its printing head 1 onto the workpiece W and performing three-dimensional scanning on the surface of the workpiece W. Here, “three-dimensional scanning” refers to a concept that combines a two-dimensional operation (so-called “two-dimensional scanning”) of scanning the irradiation position of the laser light on the surface of the workpiece W, and a one-dimensional operation of adjusting the focal position of the laser light. However, three-dimensional scanning is not essential. The laser marking apparatus L only needs to be capable of at least two-dimensional scanning.

In particular, the laser marking apparatus L according to this embodiment can emit laser light having a wavelength in the ultraviolet (UV) range as the laser light for marking on the workpiece W, for example, laser light having a wavelength of around 355 nm. In the following description, the laser light for marking on the workpiece W may be referred to as “UV laser light”or “printing laser light”to distinguish it from other laser light.

It should be noted that the laser light emitted by the laser marking apparatus L is not limited to UV laser light. The laser marking apparatus L may emit laser light included in the near-infrared (NIR) wavelength range. When using laser light included in the NIR wavelength range, the term “UV laser light”can be replaced with the term “NIR laser light”.

As shown in FIG. 1 and FIG. 2, the laser marking apparatus L according to this embodiment comprises a printing head 1, a printing controller 100, a connection cable 200, and a setting device 300.

The printing head 1 can emit printing laser light toward the printing area R1 when controlled by the printing controller 100. The printing head 1 can perform three-dimensional scanning of the printing laser light within the printing area R1.

In addition, the printing head 1 is equipped with a distance measuring unit 5 that emits and receives distance measuring light, a guide light source 61 that emits guide light for projecting a printing pattern Pm on the workpiece W, a coaxial camera 62 that receives and captures imaging light (hereinafter referred to as “imaging light”) for imaging, and a wide-area camera 7 that receives and captures imaging light separately from the coaxial camera 62, in order to realize various functions related to laser printing (refer to FIG. 2 and FIG. 4).

As illustrated in FIG. 4, the printing head 1 can perform two-dimensional scanning of not only the printing laser light but also the guide light emitted from the guide light source 61, the distance measuring light that is emitted from the distance measuring unit 5 and then reflected by the workpiece W to be received, and the imaging light received by the coaxial camera 62 to generate the captured image Pw. As described later, this two-dimensional scanning is realized by the head control unit 102 operating the laser light scanner 4.

In other words, the optical axis of the printing laser light (laser optical axis A1) is coaxialized with the optical axis of the guide light (guide optical axis A2) emitted from the guide light source 61, the optical axis of the distance measuring light (distance measuring optical axis A3) that is emitted from the distance measuring unit 5 and then reflected by the workpiece W to be received, and the optical axis of the visible light (imaging optical axis A4) received by the coaxial camera 62. Hereinafter, the coaxialized optical axis may be collectively referred to as the “scanning axis Ax”.

On the other hand, the optical axis of visible light (imaging optical axis A5) received by the wide-area camera 7 is not coaxialized with the laser optical axis A1. Hereinafter, the imaging optical axis A4 related to the coaxial camera 62 may be referred to as “first imaging optical axis A4”, and the imaging optical axis A5 related to the wide-area camera 7 may be referred to as “second imaging optical axis A5”.

The printing controller 100 is configured as a controller for controlling the printing head 1. Additionally, the printing controller 100 can store various conditions (printing conditions) for printing a desired printing pattern Pm, such as settings related to the printing pattern Pm, and can also correct these printing conditions. In this embodiment, the printing controller 100 is separate from the printing head 1.

The connection cable 200 electrically connects the printing head 1 and the printing controller 100. This connection cable 200 is, for example, composed of electrical wiring capable of transmitting and receiving electrical signals between the printing head 1 and the printing controller 100.

Furthermore, when the excitation light generation unit 110 is laid out inside the printing controller 100 as described later, the connection cable 200 may be configured by combining an optical fiber cable in addition to the aforementioned electrical wiring.

More generally, one of the printing head 1 and the printing controller 100 can be incorporated into the other to be integrated. In this case, unnecessary wiring can be appropriately omitted.

The setting device 300 functions as a terminal for setting various printing conditions and presenting information related to laser marking to the user. This setting device 300, for example, has a Central Processing Unit (CPU) and memory, and is connected to the printing controller 100 in a manner capable of sending and receiving electrical signals via wired or wireless means.

However, although the setting device 300 is configured using a personal computer such as a desktop computer or laptop computer in this embodiment, this disclosure is not limited to such a configuration.

The setting device 300 may be configured, for example, as a dedicated terminal connectable to the laser marking apparatus L, such as a touch panel console. Additionally, the setting device 300 can be incorporated into and integrated with the printing controller 100, for example.

The external device 400 is connected to the printing controller 100 as needed. In the example shown in FIG. 1, the external device 400 is composed of a conveying speed sensor 401 and a Programmable Logic Controller (PLC) 402.

The conveying speed sensor 401 is configured, for example, with a rotary encoder and can detect the conveying speed of the workpiece W. The conveying speed sensor 401 outputs a signal (detection signal) indicating its detection result to the printing controller 100. The printing controller 100 controls the two-dimensional scanning of the printing laser light and other operations based on the detection signal input from the conveying speed sensor 401.

The PLC 402 is configured, for example, with a microprocessor and can input a trigger signal to the printing controller 100. The PLC 402 is used to control the laser marking system S according to a predetermined sequence.

In addition to the aforementioned equipment and apparatus, the laser marking apparatus L can be connected wirelessly or by wire to devices for operation and control, computers for performing various other processes, storage devices, and peripheral devices.

The following explanation will be given in order: the hardware configuration of the setting device 300, printing controller 100, and printing head 1; the configuration related to data settings sent from the setting device 300 to the printing controller 100; and the configuration related to the control of the printing head 1 by the printing controller 100 based on those data settings.

### 2. Setting Device 300

As shown in FIGS. 1 and 2, the setting device 300 according to this embodiment includes a display unit 301, an operation unit 302, a storage unit 303, and a processing unit 304. The setting device 300 is a terminal operated by the user, which can also be called an “operation terminal”.

### Display Unit 301

The display unit 301 displays information to the user. More specifically, the display unit 301 displays information to the user through its display screen. This display unit 301 can be configured using a liquid crystal display or an organic EL panel.

In addition, the display screen of the display unit 301 also functions as a screen for accepting user input (hereinafter referred to as “user input”) through the operation unit 302. Specifically, the display unit 301 of this embodiment displays a setting surface R2 corresponding to the printing area R1. On this setting surface R2, input interfaces Iu for accepting input of the printing pattern Pm, such as the first interface If1 to be described later, are arranged.

The input interface Iu is configured with a graphical user interface (GUI) such as a frame indicating the range of the setting surface R2, and figures showing the position and orientation of the printing pattern Pm on the setting surface R2. Based on user input, the input interface Iu can accept input of the printing pattern Pm and display the content of the accepted printing pattern Pm on the setting surface R2.

It is not essential for the setting device 300 to include a display unit 301. The display unit 301 may be included in the printing controller 100 or the printing head 1. For example, when the setting device 300 is incorporated into the printing controller 100 or a touch panel console is used, the display screen provided on the printing controller 100 or the console can serve as the display unit.

Furthermore, the display unit according to this disclosure may be configured by a separate display from the setting device 300, printing controller 100, and printing head 1.

### Operation Unit 302

The operation unit 302 accepts the aforementioned user input and inputs an electrical signal corresponding to that user input to the CPU or the like. The operation unit 302 can be configured with a keyboard and a pointing device. The pointing device includes a mouse, joystick, etc.

It is not essential for the setting device 300 to include the operation unit 302. The operation unit 302 may be included in the printing controller 100 or the printing head 1. For example, when the setting device 300 is incorporated into the printing controller 100 or a touch panel console is used, switches, buttons, etc. provided on the printing controller 100 or the console can serve as the scanning unit.

### Storage Unit 303

The storage unit 303 stores various types of information. The storage unit 303 is composed of volatile memory such as random access memory (RAM) and read-only memory (ROM), and non-volatile memory such as hard disk drive (HDD) and solid state drive (SSD). The storage unit 303 temporarily or continuously stores information that is input by the user through the operation unit 302, preset by the manufacturer, or transmitted and received between the printing controller 100 as needed.

### Processing Unit 304

The processing unit 304 executes various processes based on the storage content of the storage unit 303. The processing unit 304 is configured with one or more processors (for example, CPU).

The processing unit 304 executes processes corresponding to each function to realize multiple different functions. For example, the processing unit 304 can set a print pattern Pm to be printed on the workpiece W and the printing conditions for printing that print pattern Pm based on user input. This function is realized, for example, by the printing setting unit 304a of the processing unit 304.

The marking pattern Pm and marking conditions set by the processing unit 304 are stored in the storage unit 303 of the setting device 300, or output to the printing controller 100 and stored in the storage unit 101 of the printing controller 100. Hereinafter, the combination of the marking pattern Pm and marking conditions is referred to as “print settings”. These print settings may be stored in the storage unit 303 of the setting device 300 as needed.

### Other Components

In addition, the processing unit 304 of this embodiment, as shown in FIG. 3, includes a printing setting unit 304a, a printing data generation unit 304b, a workflow editing unit 304c, a pre-printing process setting unit 304d, a post-printing process setting unit 304e, a GUI control unit 304f, and an input receiver 304g. Details will be described later, but some or all of these elements may be configured in the printing controller 100 instead of the setting device 300.

### 3. Printing Controller 100

As shown in FIG. 2, the printing controller 100 includes a storage unit 101 that stores printing settings transmitted from the setting device 300, a head control unit 102 that controls the printing head 1 based on these printing settings, an excitation light generation unit 110 that generates laser excitation light (excitation light), and a trigger signal receiver 120. It should be noted that it is not essential for the printing controller 100 to include the excitation light generation unit 110; the printing head 1 may include the excitation light generation unit 110. Similarly, the trigger signal receiver 120 may be provided in the setting device 300.

### Storage Unit 101

The storage unit 101 is configured to store the print settings determined by the setting device 300, and to output the stored content to the head control unit 102 as necessary.

Specifically, the storage unit 101 is composed of volatile memory such as RAM and ROM, and non-volatile memory such as HDD and SSD, and can temporarily or continuously store information indicating print settings. When the setting device 300 is incorporated into the printing controller 100, the storage unit 303 of the setting device 300 may serve dual purpose as the storage unit 101.

### Head Control Unit 102

The head control unit 102 executes a printing process that forms a predetermined printing pattern Pm within the printing area R1 by controlling the laser light generator 2 and the laser light scanner 4. Specifically, the head control unit 102 controls the excitation light generation unit 110, the laser light generator 2, and the laser light scanner 4, etc., based on the printing settings stored in the storage unit 101. Along with the printing process by the head control unit 102, laser printing (printing operation) by the printing head 1 is executed.

Specifically, the head control unit 102 has a CPU, memory, and input/output bus, and generates control signals based on signals indicating information input through the setting device 300 and signals indicating printing conditions (details described later) read from the storage unit 101. The head control unit 102 controls laser marking on the workpiece W by outputting the generated control signals to each part of the laser marking apparatus L.

For example, when starting laser marking on the workpiece W, the head control unit 102 reads the laser power stored in the storage unit 101, and outputs a control signal generated based on that laser power to the excitation light generation unit 110 to control the generation of laser excitation light.

Furthermore, when actually printing on the workpiece W, the head control unit 102, for example, reads the print pattern Pm stored in the storage unit 101, and outputs a control signal generated based on the print pattern Pm to the laser light scanner 4, performing two-dimensional scanning of the printing laser light. In this way, the head control unit 102 can control the laser light scanner 4 to realize two-dimensional scanning of the printing laser light.

### Excitation Light Generation Unit 110

The excitation light generation unit 110 oscillates laser light according to the drive current and focuses the oscillated laser light to output it as laser excitation light (excitation light). Specifically, the excitation light generation unit 110 of this embodiment is composed of an excitation light source that oscillates laser light and a focusing unit that focuses that laser. The excitation light source can be constructed, for example, with a laser diode (LD). The focusing unit can be constructed, for example, with a focusing lens.

The excitation light generated by the excitation light generation unit 110 is input to the laser light generator 2.

### Trigger Signal Receiver 120

The trigger signal receiver 120 accepts the input of a trigger signal. This trigger signal functions as a trigger to make the head control unit 102 execute the printing process. Specifically, the trigger signal receiver 120 of this embodiment is electrically connected to the PLC 402 and accepts the trigger signal output from the PLC 402. When a trigger signal is received, the trigger signal receiver 120 inputs an electrical signal indicating this to the head control unit 102. The head control unit 102 receives this electrical signal and executes the aforementioned printing process.

### Other Components

In addition, the printing controller 100 of this embodiment includes, as shown in FIG. 2, a distance measurement unit 103, an XYθ processing unit 131, a Z processing unit 132, a window inspection unit 151, a log storage unit 152, a code reading unit 153, and a print verification unit 154. As will be described in detail later, these elements are configured by one or more CPUs and execute various processes related to laser marking. Also, some or all of these elements may be configured in the setting device 300 instead of the printing controller 100. Furthermore, the aforementioned classification is merely for convenience. For example, the Z processing unit 132 or the distance measurement unit 103 may also serve as the window inspection unit 151, or the distance measurement unit 103 may also serve as the Z processing unit 132.

### 4. Printing Head 1

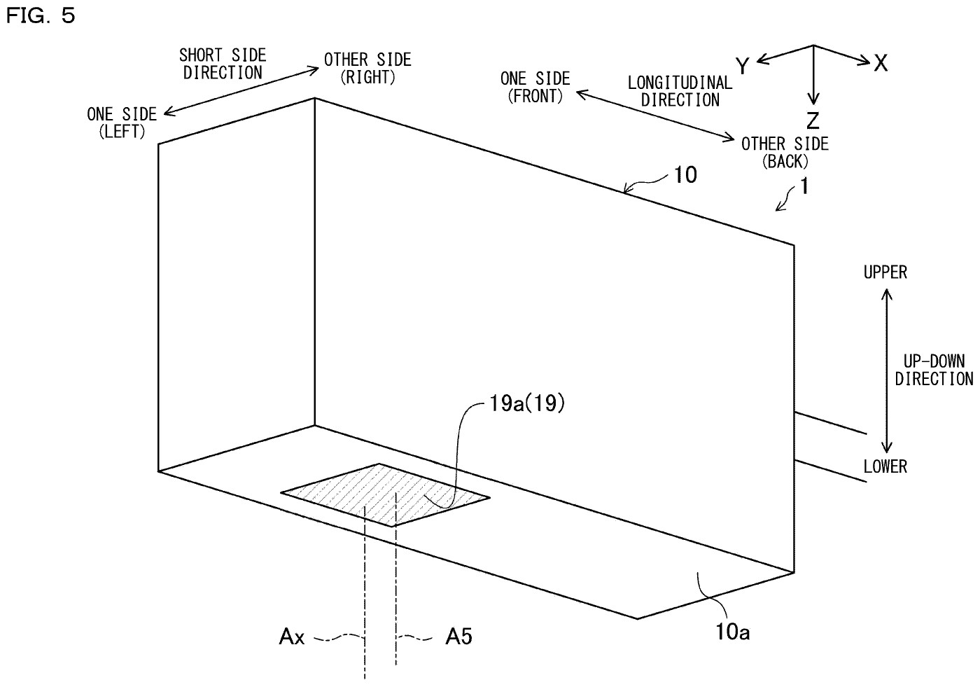

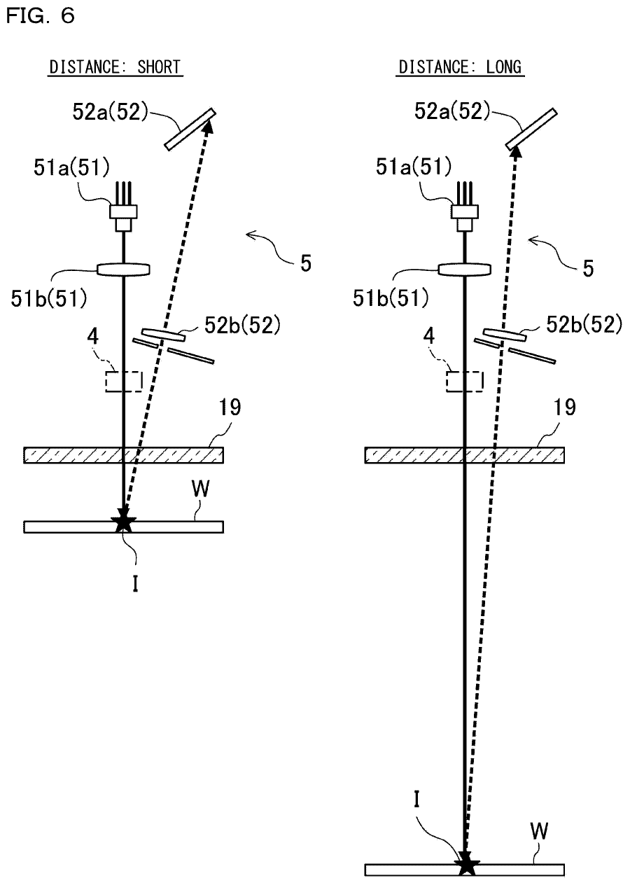

FIG. 4 is a block diagram illustrating the schematic configuration of the printing head 1 exemplified in FIG. 2 and the optical axes related to the distance measuring light. FIG. 5 is a perspective view illustrating the appearance of the printing head 1. FIG. 6 is a figure for explaining the distance measuring unit 5 and the triangulation method.

The printing head 1 generates laser light (printing laser light) based on excitation light and irradiates the workpiece W with said laser light. The laser light irradiated on the workpiece W is three-dimensionally scanned as mentioned above.

Specifically, the printing head 1 is equipped with a laser light generator 2, a height direction scanning unit 3 having a focal adjustment unit 33, a laser light scanner 4, a printing area inspection unit 6 having a coaxial camera 62, a wide-area camera 7, and a housing 10.

As shown in FIG. 4, the housing 10 incorporates a laser light generator 2, a height direction scanning unit 3 having a focal adjustment unit 33, a laser light scanner 4, a printing area inspection unit 6 having a coaxial camera 62, and a wide-area camera 7.

As shown in FIG. 5, the bottom surface of the housing 10 is partitioned by a plate-shaped bottom plate 10a. This bottom plate 10a is provided with an emission window 19 for emitting printing laser light from the printing head 1 to the outside of the printing head 1. The emission window 19 is constructed by fitting a plate-shaped transparent member 19a, through which two-dimensionally scanned printing laser light, guide light, and distance measuring light pass, into a through-hole that penetrates the bottom plate 10a in the plate thickness direction.

Furthermore, as shown in FIG. 3, multiple illumination units 18 are arranged around the emission window 19. In this embodiment, the multiple illumination units 18 are composed of four illumination units 18 (only two are shown in the figure example). These illumination units 18 are electrically connected to the printing controller 100. These illumination units 18 emit light upon receiving control signals from the printing controller 100 and irradiate the printing area R1.

Furthermore, the emission window is arranged at a reference position where the optical path length from the emission part of the distance measuring light in the distance measuring unit is known. This arrangement becomes effective in the window inspection described later.

As shown in FIG. 5, the transparent member 19a of the emission window 19 is configured to allow both the scanning axis Ax, which is scanned by the laser light scanner 4, and the second imaging optical axis A5, which is not scanned by the laser light scanner 4, to pass through. As mentioned earlier, the scanning axis Ax is formed by coaxializing the laser optical axis A1, the guide optical axis A2, the first imaging optical axis A4, and the distance measuring optical axis A3.

Furthermore, as shown in FIG. 4, with respect to the propagation direction of the laser light, the height direction scanning unit 3 and the focal adjustment unit 33 are interposed between the laser light generator 2 and the laser light scanner 4.

In the following description, the longitudinal direction of the housing 10 in FIG. 5 may be simply referred to as “longitudinal direction”, “front-rear direction”, or “X direction”, and the short side direction of the housing 10 in the same figure may be simply referred to as “short side direction”, “left-right direction”, or “Y direction”. Similarly, the height direction of the housing 10 in FIG. 5 may be simply referred to as “height direction”, “up-down direction”, or “Z direction”.

### Laser Light Generator 2

The laser light generator 2 generates printing laser light to be irradiated onto the printing area R1 of the workpiece W. Specifically, the laser light generator 2 generates printing laser light based on the excitation light generated by the excitation light generation unit 110, and outputs that printing laser light to the outside of the laser light generator 2 (for example, to the height direction scanning unit 3).

Specifically, the laser light generator 2 includes a laser oscillator 21, a beam sampler 22, and a power monitor 23. The laser oscillator 21 generates laser light with a predetermined wavelength based on excitation light, and performs wavelength conversion and amplification to oscillate printing laser light. The beam sampler 22 separates a portion of the printing laser light oscillated from the laser oscillator 21. The power monitor 23 receives the printing laser light separated by the beam sampler 22.

The laser oscillator 21 includes a laser medium 21a that performs stimulated emission corresponding to excitation light to generate a fundamental wave, a nonlinear optical crystal 21b that generates printing laser light by modulating the fundamental wave, a Q-switch (not shown) that causes the fundamental wave emitted from the laser medium 21a to pulse oscillate, and a pair of reflective mirrors (not shown) that resonate the laser light pulsed by the Q-switch.

However, the nonlinear optical crystal 21b is not essential. For example, when using an NIR laser as the printing laser, the nonlinear optical crystal 21b becomes unnecessary. In that case, the aforementioned fundamental wave will be used as the printing laser light.

The laser medium 21a is a so-called solid-state laser crystal. As the solid-state laser crystal, for example, a rod-shaped Nd: YVO4 (yttrium vanadate) can be used. This allows the laser oscillator 21 to emit laser light (NIR laser light) having a wavelength of around 1064 nm as the fundamental wave. In this case, the fundamental wave can be generated by any method such as a unidirectional excitation method using end pumping.

The nonlinear optical crystal 21b can be composed of multiple optical crystals, such as an optical crystal for generating the second harmonic and an optical crystal for generating the third harmonic. Various optical materials can be used for each optical crystal. The nonlinear optical crystal 21b is an optical element for increasing the wavelength of the fundamental wave, and functions as a “wavelength conversion element”.

For example, LBO (LiB3O3) can be used as the first wavelength conversion element that generates the second harmonic having twice the frequency of the fundamental wave. Similarly, LBO (LiB3O3) can be used as the second wavelength conversion element that generates the third harmonic having three times the frequency of the fundamental wave. However, this example is not limiting. Various types of optical materials can be utilized, such as organic nonlinear optical materials or other inorganic nonlinear optical materials.

In addition, the power monitor 23 detects the output of the printing laser light. The power monitor 23 is electrically connected to the printing controller 100 and can output its detection signal to the head control unit 102 and other units.

The printing laser light generated by the laser light generator 2 reaches the laser light scanner 4 via the height direction scanning unit 3. The optical axis (laser optical axis A1) extending in the propagation direction of the printing laser light can be divided into two at the focal adjustment unit 33 as a boundary.

Hereinafter, the laser optical axis A1 connecting the laser light generator 2 and the focal adjustment unit 33 is referred to as the upstream laser optical axis A11, and the laser optical axis connecting the focal adjustment unit 33 and the laser light scanner 4 is referred to as the downstream laser optical axis A12.

### Height Direction Scanning Unit 3

The height direction scanning unit 3 is interposed between the laser light generator 2 and the laser light scanner 4 as mentioned earlier. The height direction scanning unit 3 functions as a hub that optically connects the laser light generator 2 to the laser light scanner 4, and also optically connects the printing area inspection unit 6 to the laser light scanner 4.

Specifically, the height direction scanning unit 3 related to this embodiment comprises a first optical member 31, a second optical member 32, and the aforementioned focal adjustment unit 33. These elements are arranged in order from top to bottom along the vertical direction, as suggested in FIG. 4.

The first optical member 31 is, for example, configured with a reflective mirror that reflects the printing laser light. The first optical member 31 bends the upstream laser optical axis A11 downward, thereby reflecting the printing laser light emitted from the laser light generator 2 and guiding it to the focal adjustment unit 33.

The focal adjustment unit 33 adjusts the focal position of the printing laser light generated by the laser light generator. The printing laser light that has passed through the focal adjustment unit 33 is designed to enter the laser light scanner 4 via the second optical member 32.

Specifically, the focal adjustment unit 33 allows the printing laser light output from the laser light generator 2 and reflected by the first optical member 31 to pass through, and adjusts the focal position of that printing laser light.

The focal adjustment unit 33 also emits the printing laser light that has passed through the focal adjustment unit 33 towards the second optical member 32. The printing laser light that reaches the second optical member 32 is guided to the laser light scanner 4 via the second optical member 32.

Although details are omitted, the focal adjustment unit 33 has, for example, an incident lens that transmits the printing laser light output from the laser light generator 2, a collimating lens that transmits the printing laser light that has passed through the incident lens, an exit lens that transmits the printing laser light that has passed through the incident lens and the collimating lens, and a lens driving unit that moves the incident lens.

For adjusting the focal position, for example, the lens driving unit is operated based on the control signal from the head control unit 102. This operation changes the relative distance between the incident lens and the exit lens while maintaining the optical axes of the incident lens, collimating lens, and exit lens coaxial with respect to the printing laser light. This change displaces the focal position of the printing laser light irradiated on the workpiece W.

The focal position of the printing laser light is displaced to approach and separate from the emission window 19 of the printing head 1. In other words, the focal adjustment unit 33, which serves as the focal adjustment unit, functions as a means for scanning the printing laser light in the up-down direction. Hereinafter, the scanning direction by the focal adjustment unit 33 may be referred to as the “Z direction”.

The second optical member 32 is, for example, constructed of a mirror that reflects the printing laser light. The second optical member 32 bends the downstream laser optical axis A12 backward to reflect the printing laser light emitted from the focal adjustment unit 33 and guide it to the laser light scanner 4.

More specifically, the second optical member 32 of this embodiment is constructed of a dichroic mirror that reflects the printing laser light and transmits the guide light, distance measuring light, and imaging light. As a result, the second optical member 32 functions as a confluence part that coaxializes the downstream laser optical axis A12, the guide optical axis A2, the distance measuring optical axis A3, and the first imaging optical axis A4.

In other words, the guide optical axis A2, the distance measuring optical axis A3, and the first imaging optical axis A4 can be considered to branch from the laser optical axis A1 between the laser light generator 2 and the laser light scanner 4.

### Printing Area Inspection Unit 6

The printing area inspection unit 6 has a guide light source 61, a distance measuring unit 5, a coaxial camera 62, a first optical member 63, and a second optical member 64.

### Guide Light Source 61

The guide light source 61 emits guide light toward the workpiece W. By emitting guide light, it is possible to make the irradiation position of the printing laser light visible. Specifically, the guide light source 61 is configured to project the printing pattern Pm onto the workpiece W using the guide light. Therefore, the wavelength of the guide light is set to fall within the visible light range. As mentioned earlier, the guide light source 61 has a guide optical axis A2 that branches from the laser optical axis A1 between the laser light generator 2 and the laser light scanner 4.

As an example, the guide light source 61 related to this embodiment emits red laser light with a wavelength of around 655 nm as the guide light. The wavelength of the guide light is set to differ from the wavelengths of the printing laser light, distance measuring light, and imaging light.

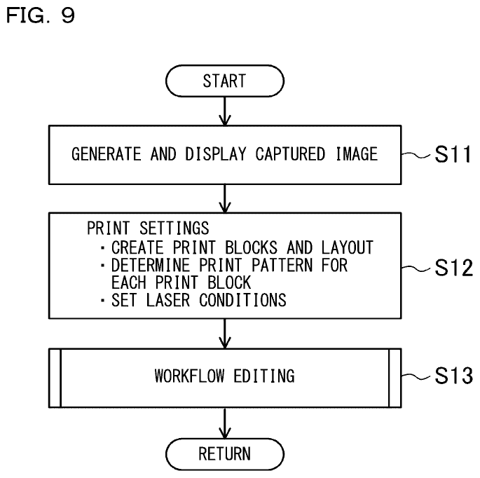

The guide light source 61 is coaxialized with the printing laser light. Specifically, the guide light emitted from the guide light source 61 propagates along the guide optical axis A2, where this guide optical axis A2 branches from the downstream laser optical axis A12 as mentioned earlier. Therefore, by appropriately operating the laser light scanner 4, the guide light can be scanned two-dimensionally within the printing area R1 exemplified in FIG. 9.

Furthermore, the guide light source 61 is electrically connected to the head control unit 102, similar to the laser light generator 2 and the laser light scanner 4. The guide light source 61 executes the emission of guide light based on the control signal output from the head control unit 102.

### First Optical Member 63

The first optical member 63 functions as a branching part that separates the guide optical axis A2 from the other optical axes A3 and A4 among the guide optical axis A2, the distance measuring optical axis A3, and the first imaging optical axis A4. The first optical member 63 can be constructed, for example, with a dichroic mirror that allows the guide light to pass through while reflecting the distance measuring light and imaging light.

### Second Optical Member 64

The second optical member 64 functions as a branching part that separates the distance measuring optical axis A3 and the first imaging optical axis A4 from each other. The second optical member 64 can be constructed, for example, with a dichroic mirror that allows one of the distance measuring light and the imaging light to pass through while reflecting the other.

### Distance Measuring Unit 5

The distance measuring unit 5 has an emission part 51 that emits distance measuring light onto the surface of the workpiece W through the laser light scanner 4, and a light receiving part 52 that receives the distance measuring light reflected by the workpiece W through the laser light scanner 4. The distance measuring unit 5 is an example of the “distance detector” in this embodiment.

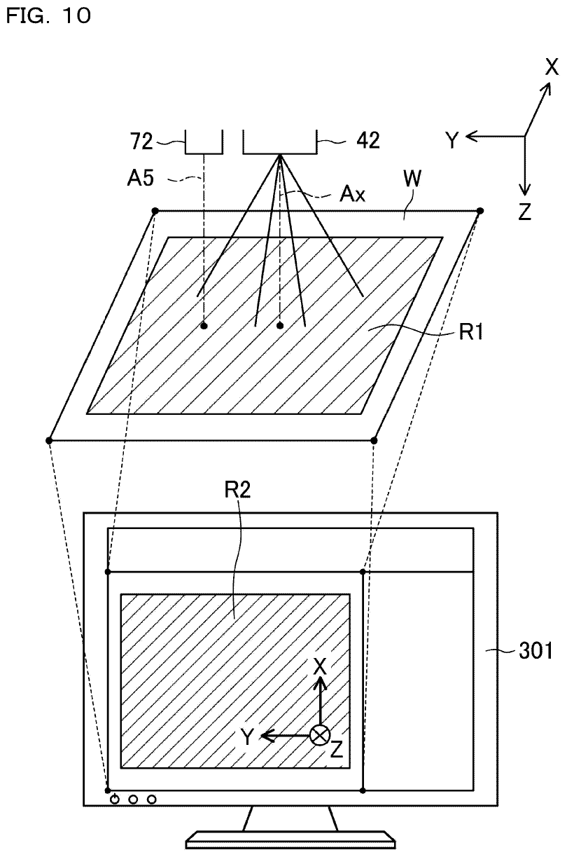

As shown by the asterisks in FIG. 6 and FIG. 10, the emission part 51 of the distance measuring unit 5 emits distance measuring light through the laser light scanner 4 towards the distance measurement position I indicating the position where the distance on the surface of the workpiece W is measured. The light receiving part of the distance measuring unit 5 receives the distance measuring light reflected at that distance measurement position I. Specifically, the emission part 51 has a distance measuring light source 51a which serves as the light source for the distance measuring light, and an optical lens 51b.

The light receiving unit 52 of the distance measuring unit 5 is configured, for example, with light receiving elements 52a, detects the light receiving position of the reflected light at each light receiving element 52a, and outputs a signal (detection signal) indicating the detection result. The detection signals output from each light receiving element are input to the printing controller 100 and reach the distance measurement unit 103. Specifically, the light receiving unit 52 has light receiving elements 52a and a light receiving lens 52b.

The laser marking apparatus L can basically measure the distance to the workpiece W (for example, the distance from the printing head 1 to the distance measurement position I on the workpiece W) based on the light receiving position of the reflected light on the light receiving surface of the light receiving part 52 (in this embodiment, the position of the spot peak). The so-called triangulation method is used as the distance measurement technique.

Specifically, when distance measuring light is emitted from the distance measuring light source 51a of the emission part 51, the distance measuring light is irradiated onto the surface of the workpiece W. When the distance measuring light is reflected by the workpiece W, the reflected light (especially diffuse reflected light) would propagate approximately isotropically if the effect of specular reflection were removed.

Thus, the propagating reflected light includes a component that enters the light receiving element 52a through the light receiving lens 52b. However, depending on the distance between the printing head 1 and the workpiece W, the incident angle of the incident light to the light receiving element 52a increases or decreases. When the incident angle to the light receiving element 52a increases or decreases, the light receiving position on its light receiving surface is displaced.

In this way, the distance between the printing head 1 and the workpiece W is associated with the light receiving position on the light receiving surface in a predetermined relationship. Therefore, by understanding this relationship in advance and storing it, for example, in the printing controller 100, the distance between the printing head 1 and the workpiece W can be calculated from the light receiving position on the light receiving surface. This calculation method is nothing other than a technique using the so-called triangulation method.

In other words, the aforementioned distance measuring unit 103 measures the distance from the laser marking apparatus L to the distance measurement position I using the triangulation method based on the light receiving position of the distance measuring light on the light receiving part 52.

Specifically, in the aforementioned storage unit 101, the relationship between the light receiving position on the light receiving surface of the light receiving part 52 and the distance from the printing head 1 to the surface of the workpiece W is stored in advance. On the other hand, the distance measuring unit 103 receives a signal indicating the light receiving position of the distance measuring light on the light receiving part 52, more specifically, the peak position of the spot formed by the reflected light of the distance measuring light on the light receiving surface.

The distance measuring unit 103 measures the distance to the surface of the workpiece W based on the input signal and the relationship stored in the storage unit 101. The obtained measurement value is, for example, input to the head control unit 102 and used for controlling the focal adjustment unit 33 etc. by the head control unit 102, or input to the Z processing unit 132 and used for tilt correction and float detection by the Z processing unit 132, or input to the setting device 300 and used for various settings by the setting device 300.

For example, the laser marking apparatus L automatically or manually determines the part (marking point) on the surface of the workpiece W that is to be marked by the printing head 1. Then, before executing the marking process, the laser marking apparatus L measures the distance to each marking point (more precisely, the distance measurement point set around the marking point) and determines the control parameters for the focal adjustment unit 33 so that the focal position corresponds to the measured distance. After operating the focal adjustment unit 33 based on the determined control parameters, the laser marking apparatus L performs the marking process on the workpiece W using the printing laser light.

### Coaxial Camera 62

The coaxial camera 62 captures an image of the workpiece W to obtain a captured image Pw. Specifically, the coaxial camera 62 has a first imaging optical axis A4 that branches from the laser optical axis A1 between the laser light generator 2 and the laser light scanner 4, and captures at least a part of the printing area R1 through the laser light scanner 4. Through this imaging, the coaxial camera 62 obtains a captured image Pw that includes at least a part of the printing area R1. The coaxial camera 62 is an example of the “imaging unit”in this embodiment.

The coaxial camera 62, although having a narrower field of view size than the wide-area camera 7 to be described later, can generate a coaxial image that relatively magnifies the printing area R1 as a captured image Pw, or perform two-dimensional scanning of the imaging area through the laser light scanner 4. The coaxial camera 62 is used, for example, to locally magnify and capture a part of the printing area R1. The captured image Pw generated by the coaxial camera 62 can be displayed on the display unit 301 with at least a part of it enlarged or reduced.

The coaxial camera 62 is coaxialized with the printing laser light. Specifically, the reflected light (imaging light) used by the coaxial camera 62 for imaging propagates along the first imaging optical axis A4 and enters the coaxial camera 62, where the first imaging optical axis A4 branches from the downstream laser optical axis A12 as mentioned earlier. Therefore, by appropriately operating the laser light scanner 4, it is possible to scan the printing area R1 exemplified in FIG. 9 two-dimensionally.

Furthermore, the coaxial camera 62 is electrically connected to the head control unit 102, similar to the laser light generator 2 and the laser light scanner 4. The coaxial camera 62 executes the generation of the captured image Pw based on the control signal output from the head control unit 102.

### Laser Light Scanner 4

The laser light scanner 4 performs two-dimensional scanning of the printing laser light generated by the laser light generator 2 within the printing area R1. Specifically, the laser light scanner 4 is configured to irradiate the laser light (printing laser light) emitted from the laser light generator 2 and passed through the focal adjustment unit 33 onto the workpiece W, and to perform two-dimensional scanning on the surface of the workpiece W (particularly within the printing area R1).

Furthermore, in more detail, the laser light scanner 4 is configured with a so-called two-axis (X-axis and Y-axis) galvanometer scanner. Specifically, this laser light scanner 4 has a first scanner 41 for scanning the printing laser light incident from the focal adjustment unit 33 in a first direction, and a second scanner 42 for scanning the printing laser light scanned by the first scanner 41 in a second direction.

Here, the second direction refers to a direction that is approximately orthogonal to the first direction. Therefore, the second scanner 42 can scan the printing laser light in a direction approximately orthogonal to the first scanner 41.

In this embodiment, the first direction is equivalent to the front-rear direction (longitudinal direction of the housing 10), and the second direction is equivalent to the left-right direction (short side direction of the housing 10). Hereinafter, the first direction will be referred to as the “X direction”, and the second direction orthogonal to it will be referred to as the “Y direction”. Both the X direction and the Y direction are orthogonal to the aforementioned Z direction.

The first scanner 41 and the second scanner 42 each have a mirror arranged at their tip and a motor that rotates this mirror. Each mirror reflects the printing laser light. Each motor adjusts the rotational orientation of the corresponding mirror. By adjusting the rotational orientation of the mirror, the reflection angle of the printing laser light by each of the first scanner 41 and the second scanner 42 can be adjusted. By adjusting the reflection angle of the printing laser light, the irradiation position of the printing laser light can be changed.

The laser light scanner 4 deflects the printing laser light toward the printing area R1 by operating the first scanner 41 and the second scanner 42 according to the pre-created print settings. The deflected printing laser light passes through the emission window 19 provided in the housing of the printing head 1 and is irradiated into the printing area R1. With this printing laser light, a desired printing pattern Pm can be printed within the printing area R1.

Furthermore, as mentioned earlier, not only the printing laser light but also the guide light and distance measuring light that have passed through the second optical member 32 of the height direction scanning unit 3 are incident on the laser light scanning unit 4. The laser light scanning unit 4 of this embodiment can perform two-dimensional scanning of the incident guide light or distance measuring light by operating the first scanner 41 and the second scanner 42 respectively.

Similarly, as mentioned earlier, the laser optical axis A1 of the printing laser light is also coaxialized with the first imaging optical axis A4 of the coaxial camera 62. The laser light scanner 4 of this embodiment can perform two-dimensional scanning of the intersection point between the first imaging optical axis A4 and the workpiece W, that is, the imaging position by the coaxial camera 62, by operating the first scanner 41 and the second scanner 42 respectively.

### Wide-Area Camera 7

The wide-area camera 7 can generate a captured image Pw with a wider field of view size than the image generated by the coaxial camera 62 by capturing the workpiece W without the intervention of the laser light scanner 4. The wide-area camera 7 is another example of the “imaging unit”in this embodiment.

However, in this disclosure, it is not essential to include both the coaxial camera 62 and the wide-area camera 7 as imaging units. Various processes to be described later may be realized using either the coaxial camera 62 or the wide-area camera.

The wide-area camera 7 is configured as an imaging means that is non-coaxial with the printing laser light. Although the wide-area camera 7 cannot perform two-dimensional scanning through the laser light scanning unit 4, it has a wider field of view than the coaxial camera 62 and can generate a wide-area image as the captured image Pw, which captures the printing area R1 with a relatively wide field of view. The wide-area camera 7 is used, for example, to capture the entire printing area R1 at once.

The captured image Pw generated by the wide-area camera 7 can be displayed on the display unit 301 with at least a part of it zoomed in or out. The display unit 301 can display the captured image Pw generated by the wide-area camera 7 and the captured image Pw generated by the coaxial camera 62 side by side, or selectively display one of the two types of captured images Pw.

The wide-area camera 7 related to this embodiment is arranged directly above the emission window 19, and is fixed with its imaging lens directed downward. As mentioned earlier, the second imaging optical axis A5 of the wide-area camera 7 is not coaxialized with the optical axis A1 of the printing laser light (refer to FIG. 4 and FIG. 9).

Hereinafter, when it is unnecessary to distinguish between the wide-area camera 7 and the coaxial camera 62, they may be collectively referred to as “imaging unit 62, 7”.

### 5. Usage Method of Laser Marking System

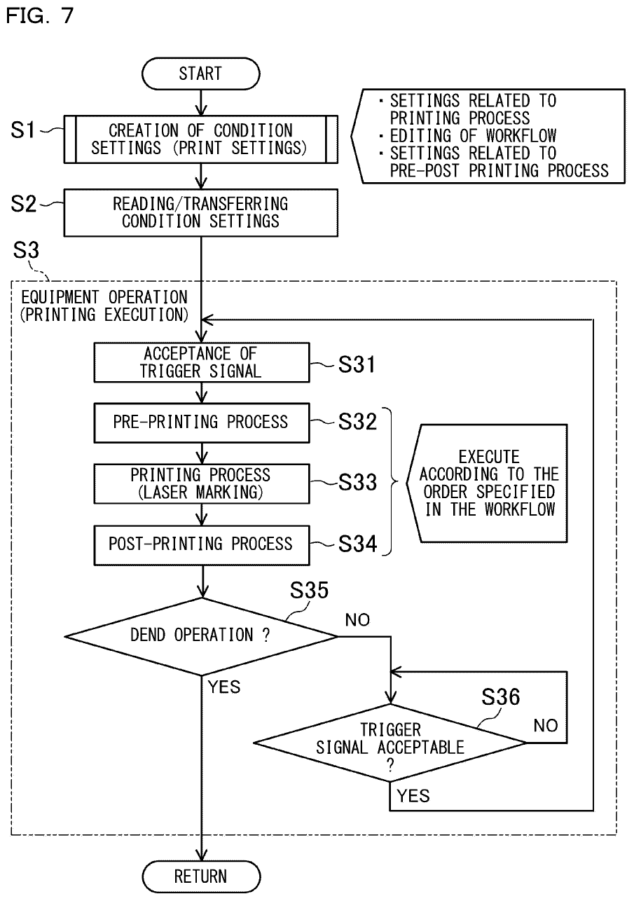

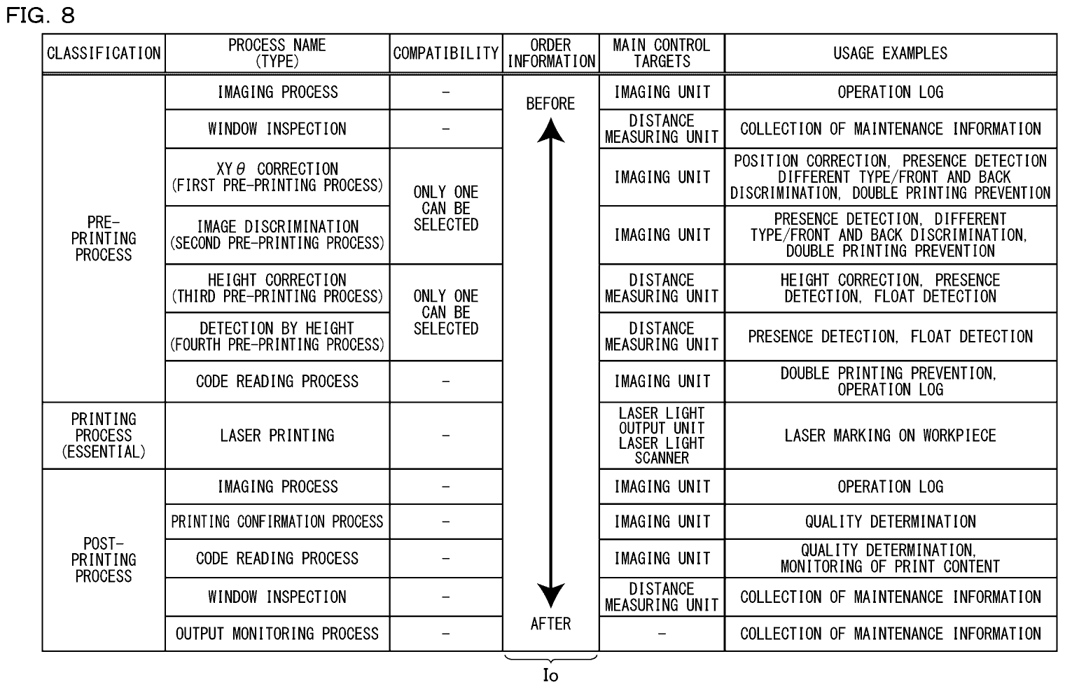

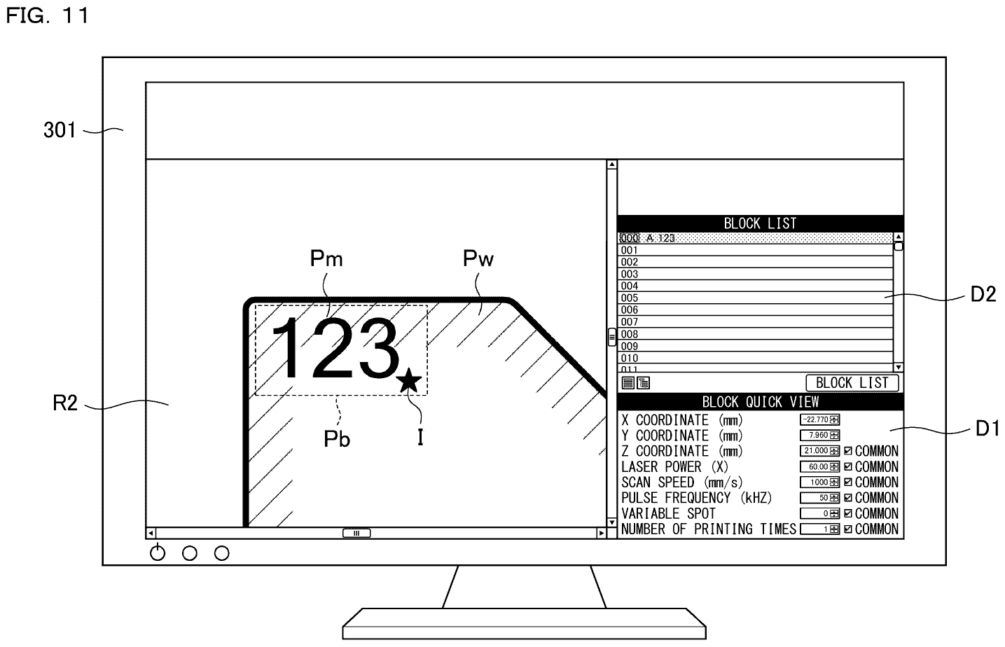

FIG. 7 is a flowchart showing the usage procedure of the laser marking system S. FIG. 8 is a table displaying a list of the breakdown of pre-printing processes, printing processes, and post-printing processes, the compatibility of each process, order information, and usage examples of each process. FIG. 9 is a flowchart illustrating the processes related to print settings and workflow editing. FIG. 10 is a figure exemplifying the relationship between the printing area R1 and the setting surface R2. FIG. 11 is a figure illustrating examples of display content on the display unit 301.

### Outline of Usage Method

The laser marking system S equipped with the laser marking apparatus L can be installed and operated, for example, on a conveyor line in a factory's production line where multiple workpieces W are sequentially conveyed. For its operation, first, prior to the activation of the conveyor line, create condition settings for the installation position of the workpiece W that will flow through the conveyor line, as well as the output of the printing laser light and distance measuring light to be irradiated on that workpiece W (Step S1 in FIG. 7).

The setting content created in this step S1 is either stored in the printing controller 100 after prior creation or read by the printing controller 100 immediately after creation (step S2 in FIG. 7).

Then, when the conveyor line starts operating, the printing controller 100 refers to the setting content that has been previously stored or read immediately after creation. The laser marking apparatus L is operated based on the referenced setting content, and sequentially executes laser marking on each workpiece W supplied through the conveyor line (Step S3 in FIG. 7).

Hereinafter, the workpiece W used for various settings such as the aforementioned condition setting may be referred to as a “preparation workpiece W” or “setting target W”, and each workpiece W that is sequentially conveyed as a printing target as a result of operating the conveyor line may be referred to as a “new workpiece W′” or “printing target W′”. When it is unnecessary to distinguish between the setting target W and the printing target W′, it may simply be referred to as “workpiece W”.

Furthermore, the captured image generated by imaging the preparation workpiece W with the imaging unit 62, 7 may be assigned the code “Pw”, while the captured image generated by imaging the aforementioned “printing target W′” may be assigned the code “Pw′”. When it is unnecessary to distinguish between the setting target W and the printing target W′, it may simply be referred to as “captured image Pw”.

### Regarding the Workflow

Here, as exemplified by substeps S31 to S33 that constitute step S3, the printing controller 100 of the laser marking apparatus L executes a series of processes including the printing process and other processes added as necessary when operating the apparatus L. The printing controller 100 is an example of the “controller” in this embodiment. Hereinafter, “substep”will be simply referred to as “step”.

Although details will be described later, the aforementioned series of processes is, as shown in step S31 and step S36, a process executed by the printing controller 100 as the controller from the time a trigger signal is input to the trigger signal receiver 120 until it transitions to a state where it can accept another trigger signal input.

Furthermore, the “other processing” mentioned here is divided into two categories based on the before-and-after relationship with the printing process (Step S33): “pre-printing process (Step S32)” which is performed before the execution of the printing process, and “post-printing process (Step S34)” which is performed after the execution of the printing process. It is not mandatory to execute both the pre-printing process and the post-printing process. Both the pre-printing process and the post-printing process may be omitted, or only one of them may be executed.

Meanwhile, as illustrated in FIG. 8, the pre-printing process and post-printing process are each composed of numerous processes. Until now, the workflow that defines a series of processes (operations) including the printing operation has been manually set by the user. However, such settings require knowledge about the role of each process, which is inconvenient from the viewpoint of user convenience.

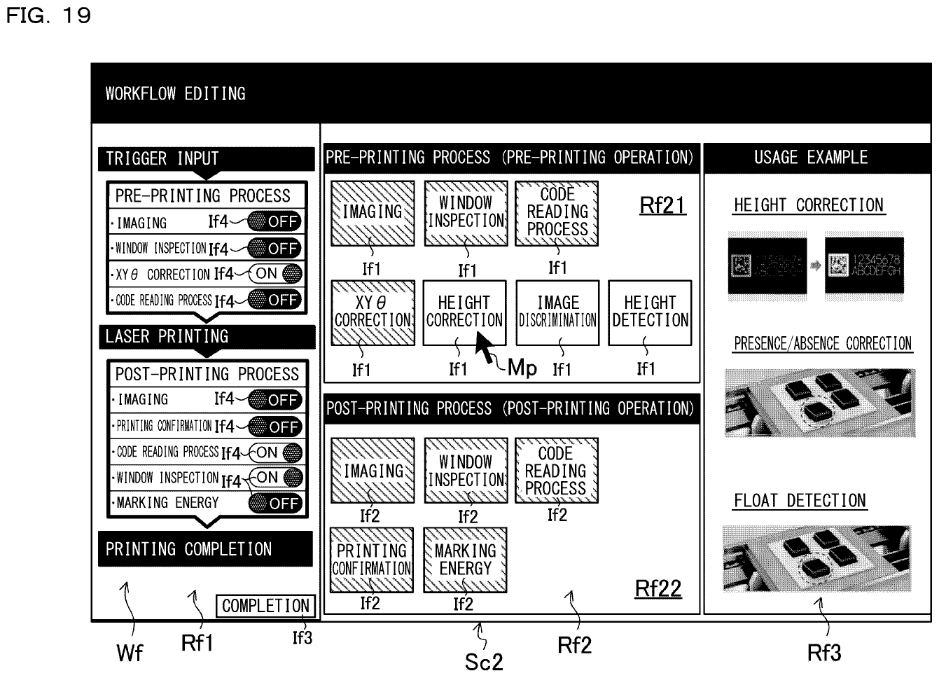

In contrast, the laser marking apparatus L according to this embodiment is equipped with a workflow Wf editing function when creating condition settings in step S1, as exemplified in FIG. 7 (for example, refer to FIG. 19 to FIG. 21 described later). This editing function is designed to automatically reflect the execution order of each process, resulting in excellent user convenience. Then, the laser marking apparatus L is configured to execute each process according to the order specified in the workflow Wf during steps S31 to S33 that are executed during operation.

The following explains the basic concepts and specific examples related to “marking settings in laser marking”, “pre-marking process”, “pre-marking operation”, and “workflow editing”in order based on step S1 of the flow in FIG. 7.

### Creation Procedure for Each Setting

FIG. 9 illustrates specific processes in Step S1 of FIG. 7. As shown in FIG. 9, in this embodiment, the control process related to print settings and the control process related to editing the workflow Wf are executed sequentially. Each control process is configured as an independent process without overlapping with each other.

First, in step S11, the imaging units 62 and 7 incorporated in the laser marking apparatus L generate a captured image Pw that includes at least a part of the printing area R1. The captured image Pw generated by the imaging units 62 and 7 is output to the setting device 300.

The display unit 301 of the setting device 300 displays a setting surface R2 associated with the printing area R1, and also displays a captured image Pw on the setting surface R2 (see FIG. 11). The captured image Pw is superimposed on the setting surface R2.

This allows the coordinate system (virtual coordinate system) defined on the setting surface R2 of the display unit 301 to be associated with the coordinate system (camera coordinate system) defined on the captured image Pw (see XYZ directions in FIG. 10).

### Creation of Print Settings

In the subsequent step S12, the print setting unit 304a defines the print settings. The print setting unit 304a defines the print settings by reading out the stored contents from the storage unit 303 or other storage, or by reading in operation inputs through the setting device 300.

The print settings include a print pattern Pm indicating the print content (marking shape) and print conditions indicating various settings and conditions related to the print pattern Pm. The print conditions include at least settings related to the print block Pb.

In this embodiment, the printing setting unit 304a exemplified in FIG. 2 sets the position and orientation of the printing pattern Pm to be printed on the workpiece W on the setting surface R2 displayed on the display unit 301. The position and orientation of the printing pattern Pm can be set through the print block Pb. The term “orientation” of the printing pattern Pm includes the rotation angle (θ) of the printing pattern Pm on the XY plane.

The print block Pb can be used to adjust the layout (position), size, and rotational orientation of the print pattern Pm. Additionally, the print block Pb is used in association with the aforementioned distance measurement position I.

The display unit 301 can display the printing pattern Pm and the printing block Pb superimposed on the captured image Pw. For example, in FIG. 11, a printing pattern Pm consisting of the numbers “123” and a rectangular printing block Pb surrounding it are arranged on the setting surface R2 on the surface of the workpiece W. As shown in the figure, the display unit 301 displays the arranged printing pattern Pm and printing block Pb superimposed on the captured image Pw.

The shape of the print block Pb is not limited to the illustrated example. Any shape can be used as long as it suggests the position and size of the print pattern Pm. Moreover, the terms “print pattern” and “print block” are merely introduced for convenience and are not intended to limit their uses.

Although not illustrated, multiple workpieces W may be displayed on the setting surface R2, or as exemplified in FIG. 10, only one workpiece W may be displayed. Additionally, multiple print blocks Pb may be arranged on a single workpiece W, or one or multiple print blocks Pb may be arranged on some or all of multiple workpieces W.

Returning to step S12 in FIG. 9, in this step, for example, the user manually creates a print block Pb and places that print block Pb on the setting surface R2. As mentioned earlier, since the setting surface R2 and the captured image Pw are associated with each other, the user can place the print block Pb while visually recognizing the captured image Pw.

Then, when one or more print blocks Pb are arranged, the user determines the print pattern Pm for each print block Pb. The determination of the print pattern Pm is executed, for example, by the user operating the operation unit 302, and the marking setting unit 304a accepting the operation input at that time through the input receiver 304g.

Furthermore, the aforementioned printing conditions that constitute the print settings may include, in addition to the settings related to the print block Pb, conditions related to the printing laser light (hereinafter referred to as “laser conditions”).

These laser conditions include one or more of the irradiation position of the printing laser light, the target output (laser power) of the printing laser light, and the scanning speed (scan speed) of the printing laser light by the laser light scanner 4. As exemplified in the menu D1 displayed in the lower right of FIG. 10, such printing conditions (laser conditions) can be set for each print block Pb.

In addition, the laser conditions may be a combination of one or more of Q-switch frequency, defocus amount (variable spot value), and scan line interval. Here, the defocus amount indicates the magnitude of deviation between the focal position of the printing laser light in the height direction and the surface of the workpiece W. By setting the defocus amount to a non-zero value, the spot diameter of the printing laser light can be changed. The number of printing times indicates the number of times each line element is repeatedly scanned when the printing pattern Pm is decomposed into multiple line elements. The scan line interval indicates the spacing between scan lines constituting each line element (especially, the spacing in the direction perpendicular to the scanning direction).

The determination of laser conditions is executed, for example, when the user inputs numerical values etc. to each item in menu D1 through the operation unit 302, and the printing setting unit 304a accepts the input content at that time through the input receiver 304g.
The printing setting unit 304a reads the arranged print blocks Pb, and the printing patterns Pm and laser conditions determined for each print block Pb, and defines their combination as the printing settings.

In this embodiment, the marking data corresponding to the marking pattern Pm, print block Pb, and laser conditions set by the marking setting unit 304a is created by the marking data generation unit 304b.

The marking data related to this embodiment includes at least data concerning the position and orientation of the marking pattern Pm, that is, data related to the print block Pb.

When the marking data is generated, the setting device 300 advances the control process from step S12 to step S13. In step S13, the setting device 300 executes the editing of the aforementioned workflow Wf.

The following provides a brief explanation of the pre-printing processes and post-printing processes that can constitute the workflow Wf, and then returns to step S13 in FIG. 9 to explain the editing procedure for the workflow Wf.

### Basic Concept of Pre-printing Process

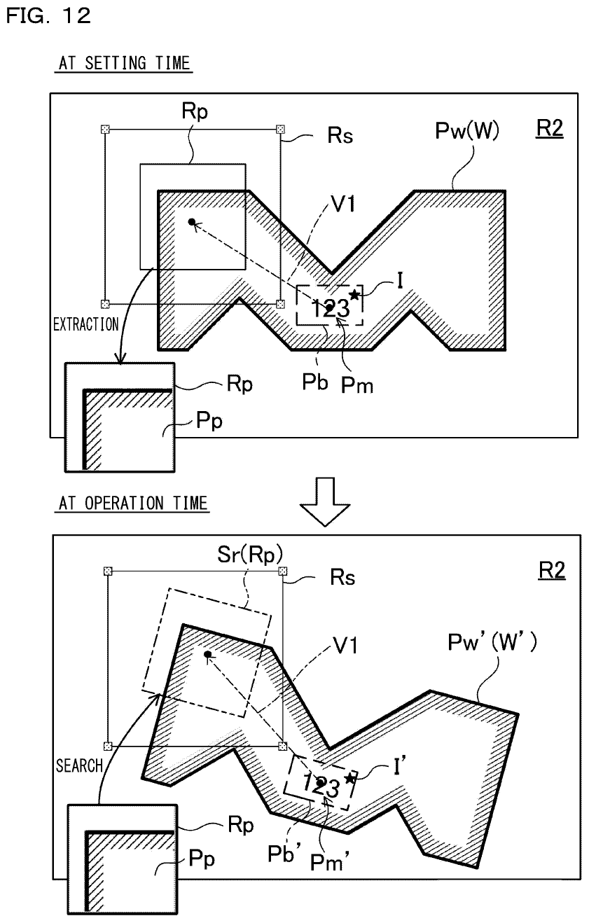

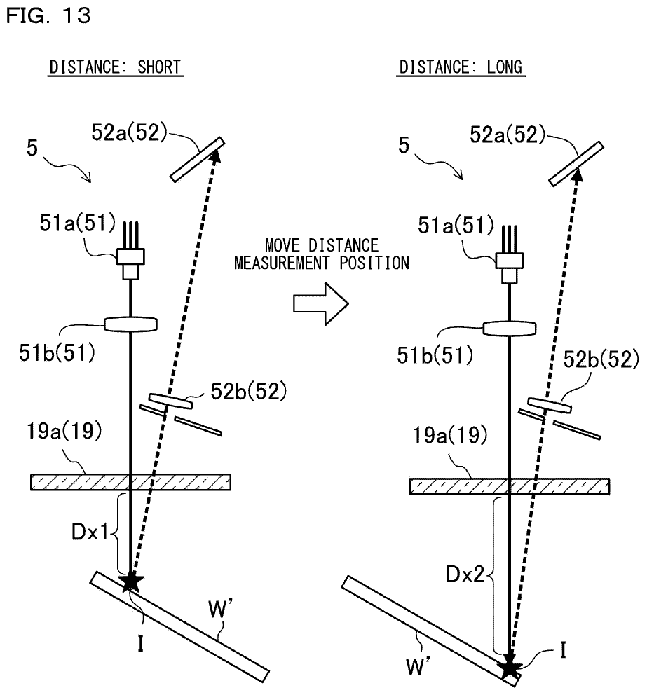

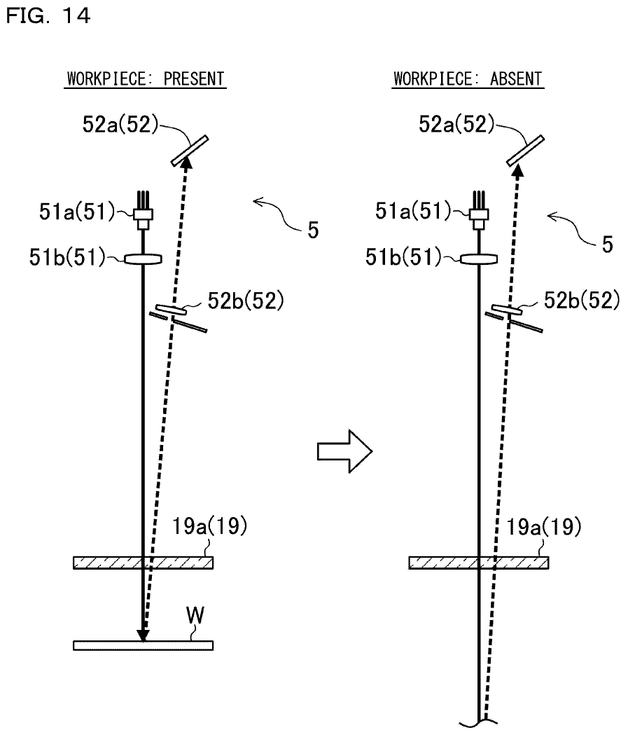

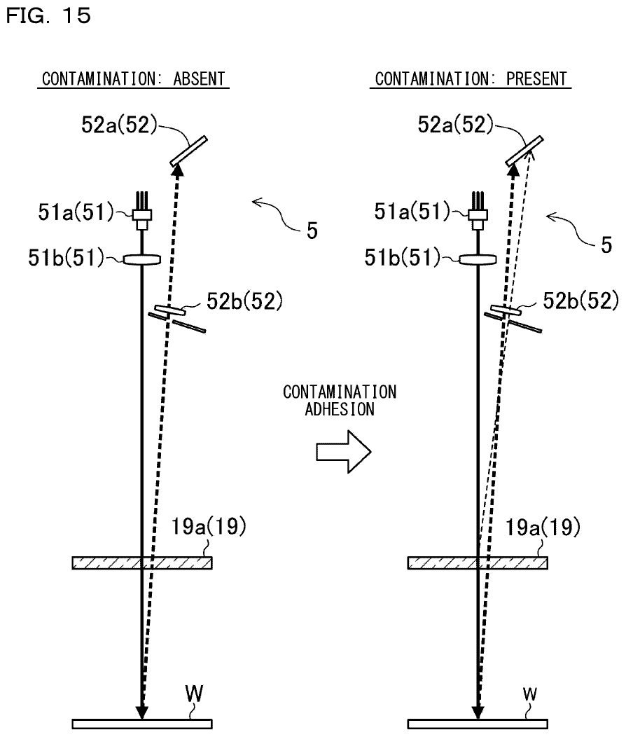

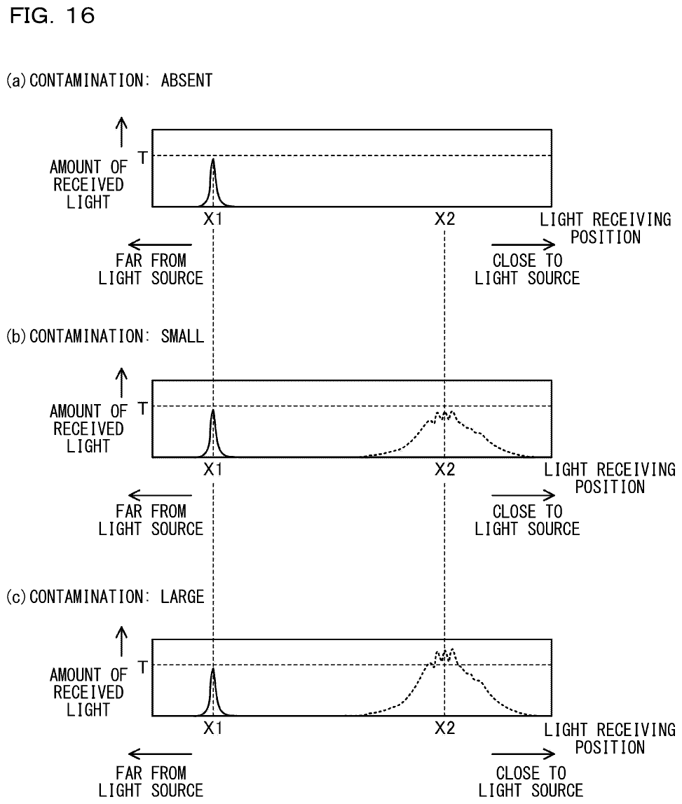

FIG. 12 is a diagram for explaining pattern search. FIG. 13 is a diagram for explaining tilt correction. FIG. 14 is a diagram for explaining height detection. FIG. 15 is a diagram for explaining window inspection. FIG. 16 is a diagram for explaining the effect of contamination on the transparent member 19a.

The pre-printing process is a process performed by the printing controller 100 before the printing process. The operation performed by the printing head 1 through the pre-printing process can be called “pre-printing operation”.

The difference between “pre-printing process” and “pre-printing operation” is merely that the subject performing each process or operation is either the “printing controller 100” or the “printing head 1”. The same applies to the difference between “post-printing process” and “post-printing operation” which will be described later. The terms “first pre-printing process” to “fourth pre-printing process”, which will be described later, may also be replaced with the terms “first pre-printing operation” to “fourth pre-printing operation” depending on the subject performing each process or operation.

In the pre-printing process, the printing controller 100 controls at least one of the imaging units 62, 7 and the distance measuring unit 5, as exemplified by “XYθ correction”, “image discrimination”, “height correction”, and “height detection” in FIG. 8. Additionally, it executes processing through the distance measurement unit 103, XYθ processing unit 131, and Z processing unit 132, etc., to acquire information related to at least one of the position and orientation of the workpiece W.

Here, the pre-printing process includes at least one or more of the first pre-printing process, the second pre-printing process, the third pre-printing process, and the fourth pre-printing process. The first pre-printing process, the second pre-printing process, the third pre-printing process, and the fourth pre-printing process are exemplified in this embodiment by “XYθ correction”, “image discrimination”, “height correction”, and “height detection” in FIG. 8, respectively.

### XYθ Correction and Image Discrimination

In XYθ correction, the XYθ processing unit 131 determines the position and orientation of the printing target W′ relative to the laser marking apparatus L based on the captured images Pw, Pw′ obtained through the imaging units 6, 72. The XYθ processing unit 131 also corrects the printing data so that the position and orientation of the printing pattern Pm are corrected according to the position and orientation of the printing target W′, based on the determination result. In XYθ correction, the XYθ processing unit 131 can also determine whether printing processing is possible for the printing target W′, instead of or in addition to correcting the printing data.

In image discrimination, the XYθ processing unit 131 determines the position and orientation of the printing target W′ relative to the laser marking apparatus L based on the captured images Pw, Pw′ obtained through the imaging units 6, 72. The XYθ processing unit 131 also determines the feasibility of the printing process for the printing target W′ based on that determination result.

Specifically, as illustrated in FIG. 12, the XYθ processing unit 131 can determine the position and orientation of the printing target W′ using various methods, and execute processing based on the determination result. Such processing includes, for example, determining the deviation in position and orientation of the printing target W′ relative to the setting target W, and executing processing based on that determination result.

Hereinafter, to distinguish from the Z-direction misalignment described later, the position of the printing target W′ in the XY direction and the misalignment of the orientation of the printing target W′ caused by rotation on the XY plane are collectively referred to as “XY misalignment” or “XYθ misalignment”. This XY misalignment can vary for each printing target W′ conveyed by the conveyor line, and can also be rephrased as the position and orientation error (workpiece error) for each printing target W′.

It should be noted that the term “XY misalignment” is used in a broad sense. In other words, the “determination of XY misalignment” referred to here includes not only the process of calculating the deviation in position and orientation of the printing target W′ with respect to the setting target W, as mentioned earlier, but also the determination of the presence or absence of the printing target W′, that is, whether the position and orientation of the printing target W′ can be identified or not.

In this embodiment, for both XYθ correction and image discrimination, the XYθ processing unit 131 of the printing controller 100 calculates the position and orientation deviation of the printing target W′ using pattern search.

The effect of XY misalignment on the printing process can be reduced or eliminated by correcting the position and orientation deviation of the printing pattern Pm for each printing target W′, except in cases where the position, etc. of the printing target W′ cannot be identified.

In other words, due to the XY misalignment of the workpiece W, the marking pattern Pm to be printed on that workpiece W will have a relative positional and orientation deviation (deviation from the desired position and orientation) with respect to the workpiece W. The laser marking apparatus L according to this embodiment can perform correction of the position in the XY direction and the orientation on the XY plane of the marking pattern (i.e., correction of the marking pattern Pm related to XY misalignment) to reduce or eliminate the latter deviation.

As an example, in the case of XYθ correction as the first pre-printing process, the position and orientation of the printing pattern Pm are adjusted through the position and orientation of the print block Pb. The laser marking apparatus L can perform the “correction of the printing pattern Pm related to XY misalignment” mentioned earlier by adjusting the print block Pb through correcting the printing data. As a result, the relative position and orientation misalignment of the printing pattern Pm with respect to the workpiece W, caused by the XY misalignment of the workpiece W, is corrected through the print block Pb corresponding to that printing pattern Pb. However, correction through the print block Pb is not essential.

On the other hand, in the case of image discrimination as the second pre-printing process, if the position and orientation of the printing target W′ cannot be identified, the laser marking apparatus L, for example, stops laser marking on that printing target W′. This allows for appropriate handling even if the printing target W′ is not actually being conveyed.

Specifically, when configuring settings before operation related to XYθ correction, the pre-printing process setting unit 304d of the setting device 300 sets a pattern area Rp used in pattern search based on user input (refer to FIG. 12). The position, orientation, and size of the pattern area Rp are, for example, determined in relation to the captured image Pw. This captured image Pw is an image generated by capturing the setting target W.

Then, the XYθ processing unit 131 sets a search area Rs to be used in pattern search based on user input (see FIG. 12). The search area Rs should be set to include at least the pattern area Rp. The position, orientation, and size of the search area Rs are, for example, determined with respect to the setting surface R2.

It should be noted that setting a search area Rs is not mandatory. Instead of setting a search area Rs, it is also possible to perform a pattern search on the entire captured image Pw. Even when configured in this way, by treating the entire captured image Pw in the same manner as the search area Rs, equivalent processing as described below can be performed.

As shown in FIG. 12, the pre-printing process setting unit 304d extracts image information within the pattern area Rp. The image information may be a pattern image Pp extracted from the captured image Pw within the pattern area Rp, or it may be edge information of the captured image Pw within the pattern area Rp.

As shown in FIG. 12, the pre-printing process setting unit 304d stores the relative position and orientation relationship (hereinafter referred to as “relative positional relationship”) between the pattern area Rp and the print block Pb in the storage unit 303, associated with the aforementioned image information. This completes the setting for XYθ correction.

Subsequently, during the operation of the laser marking apparatus L, the XYθ processing unit 131 captures an image of the printing target W′ to generate a captured image Pw′. The XYθ processing unit 131 determines the position and orientation of the pattern area Rp on the captured image Pw′ by executing a pattern search within the same search area Rs as during the setting time. This determination can be made, for example, based on the position and orientation of the image information (pattern image Pp) (refer to the virtual line Sr).

Specifically, the XYθ processing unit 131 compares the image information (pattern image Pp) previously extracted on the initial workpiece W with the newly extracted image information (image within the search area Rs) on a different new workpiece W′, to find an area within the search area Rs where the two image information highly match compared to other areas, as indicated by the virtual line Sr. This search can be conducted based on the high and low correlation values. This correlation value is a parameter that serves as an index in pattern search.

After that, the XYθ processing unit 131 corrects the position and orientation of the print block Pb by correcting the print data based on the relative positional relationship between the pattern area Rp and the print block Pb.

With this correction, the printing pattern Pm associated with the print block Pb will be corrected accordingly. As shown in FIG. 12, a print block Pb′ that considers XY misalignment can be provided, and a corrected printing pattern Pm′ can be printed along with the print block Pb′.

On the other hand, during image discrimination, the XYθ processing unit 131 searches for the position and orientation of the pattern area Rp on the captured image Pw′ through pattern search based on image information (pattern image Pp), similarly to XYθ correction.

Image discrimination is the same as XYθ correction, except that it only determines whether the “pattern area Rp” set in advance, and consequently the printing target W′, has been found during pattern search, and does not perform correction of the printing pattern Pm (“position correction”in terms of the usage example in FIG. 8) based on the determination result.

XYθ correction and image discrimination can be considered as the same type of process in that they both use pattern search. XYθ correction can provide the same function as image discrimination depending on its settings, such as turning off the correction function.

In other words, during the editing of the workflow Wf before moving to the XYθ correction settings, the image discrimination process that can provide the same function depending on the XYθ correction settings is presented to the user as an addition candidate. By adopting this configuration, it is possible to present functions that can be realized depending on the settings, directly add them to the workflow Wf, and present setting items corresponding to the added functions. As a result, the convenience for users who are unfamiliar with utilizing the imaging units 6 and 72 in the laser marking apparatus L is improved.

XYθ correction and image discrimination can be used for various purposes related to the printing target W′ through the setting of the pattern area Rp. For example, as illustrated in FIG. 8, the type and front/back of the printing target W′ may be determined by XYθ correction and image discrimination. The determination of type mentioned here includes determining whether the workpiece W and the printing target W′ are of different types. Additionally, by setting the image information within the pattern area Rp to include printed items, patterns, etc. on the workpiece W, it is possible to determine whether the printing pattern Pm has already been printed on the printing target W′ (prevention of double printing).

### Height Correction and Height Detection

In the height correction as the third pre-printing process, the pre-printing process setting unit 304d adjusts the focal position through the focal adjustment unit 33 based on the distance to the distance measurement position I obtained via the distance measuring unit 5. In the height correction, the pre-printing process setting unit 304d converts the light receiving position detected by the distance measuring unit 5 into the distance to the distance measurement position I through the distance measurement unit 103, and executes various processes. The pre-printing process setting unit 304d can also determine the feasibility of the printing process on the printing target W′ instead of or in addition to correcting the printing data.

In the height determination as the fourth pre-printing process, the pre-printing process setting unit 304d determines the feasibility of the printing process for the printing target W′ based on the distance to the distance measurement position I obtained through the imaging units 6 and 72.

Specifically, as illustrated in FIG. 6, the printing controller 100 can identify the height of the printing target W′ through the distance to the distance measurement position I, and execute processing based on the determination result. Such processing includes, for example, determining the deviation in position and orientation of the printing target W′ with respect to the setting target W, and executing processing based on that determination result.

Hereinafter, the height of the printing target W′ in the Z direction, and the misalignment of the orientation of the printing target W′ (also referred to as tilt) caused by rotation around the central axis parallel to the XY plane, are collectively referred to as “Z misalignment”. This Z misalignment can vary for each printing target W′ conveyed by the conveyor line, and can be considered as one element of the position and orientation error (workpiece error) for each printing target W′.

It should be noted that the term “Z-axis misalignment” is used in a broad sense. In other words, the “determination of Z-axis misalignment” referred to here includes not only the process of calculating the deviation in position and orientation of the printing target W′ with respect to the setting target W as mentioned earlier, but also the determination of the presence or absence of the printing target W′, that is, whether the position and orientation of the printing target W′ can be identified or not.

The effect of Z-axis misalignment on the printing process can be reduced or eliminated by adjusting the focal position (correcting the Z coordinate) according to the height position (Z coordinate) of each printing target W', and if necessary, further adjusting the focal position (tilt correction) according to the orientation of the printing target W', except in cases where the position of the printing target W′ cannot be determined.

For example, as illustrated by distances D×1 and D×2 in FIG. 13, when the printing target W′ is tilted, the distance measurement results will differ for each distance measurement position I. In this case, the pre-printing process setting unit 304d can detect the tilt of the printing target W′ based on the positional relationship between the distance measurement positions I and the relationship with the distance measurement results.

In this case, during height correction, the Z processing unit 132 changes the focal position individually for each printing point according to the tilt of the printing target W′ (tilt correction). This allows for correcting the effect of misalignment in the orientation of the printing target W′. However, tilt correction is not essential in height correction. In the usage example in FIG. 8, the correction of the Z-coordinate of the printing target W′ and the tilt correction are collectively referred to as “height correction”.

Furthermore, as illustrated in FIG. 14, when the printing target W′ is not conveyed to the desired position, the light receiving part 52 may not be able to receive the distance measuring light, or even if it can receive it, it will be received at a position significantly different from the setting time. The pre-printing process setting unit 304d can detect the presence or absence of the printing target W′ based on such information.

Height detection is the same as height correction, except that it does not perform Z-coordinate correction and tilt correction. Both height correction and height detection can be considered as similar processes in that they use the distance measurement results from the distance measuring unit 5. Height correction can provide the same function as height detection depending on its settings, such as when the correction function is turned off.

In other words, during the editing of the workflow Wf before moving to the height correction settings, the height detection, which can provide the same function depending on the height correction settings, is presented to the user as an addition candidate. By adopting this configuration, it is possible to present functions that can be realized depending on the settings, directly add them to the workflow Wf, and present setting items corresponding to the added functions. As a result, the convenience for users who are unfamiliar with the utilization of the distance measuring unit 5 in the laser marking apparatus L is improved.

Height correction and height detection can be used for various purposes related to the printing target W′ through prior settings. As illustrated in FIG. 8, in addition to detecting the presence or absence of the printing target W′, floating of the printing target W′ may be detected by height correction and height detection. The “floating” referred to here means a case where the printing target W′ is partially separated from the conveyor line, resulting in the aforementioned tilt.

### Maintenance Process (Window Inspection)

The pre-printing process may further include a maintenance process (refer to “Window Inspection” in FIG. 8). This maintenance process is configured so that the printing controller 100 controls the distance measuring unit 5 to acquire maintenance information of the laser marking apparatus L.

The maintenance process is executed by the window inspection unit 151. The window inspection unit 151 detects contamination on the transparent member 19a by identifying the distance measuring light caused by the reflected light from the transparent member 19a among the distance measuring light received by the light receiving part 52 of the distance measuring unit 5.

As the operation of the laser marking apparatus L continues, contamination may adhere to the transparent member 19a. When it becomes dirty, it may affect the measurement by the distance measuring unit 5 or the marking quality by the printing laser light.

In other words, when there is not much contamination adhering, as shown in the left figure of FIG. 15, the distance measuring light passes through the transparent member 19a without being reflected by the contamination adhering to it. In this case, if we ignore the effect of specular reflection, as shown in (a) of FIG. 16, the light receiving element 52a detects only the reflected light that forms a peak at a predetermined position X1 after being reflected by the surface of the workpiece W.

However, if the transparent member 19a becomes excessively dirty, as shown in the right figure of FIG. 15, at least a part of the distance measuring light will be reflected by the dirt adhering to the transparent member 19a. In this case, as shown in FIG. 16(b) and (c), the light receiving element 52a will detect reflected light that forms a peak at a predetermined position X2 (≠X1) due to reflection from the surface of the transparent member 19a. The amount of received light from this reflection increases as the transparent member 19a becomes dirtier.

In particular, as shown in FIG. 16(b) and (c), depending on the contamination condition of the transparent member 19a, the light receiving element 52a may detect both the distance measuring light reflected by the surface of the workpiece W and the distance measuring light reflected by the transparent member 19a.

In contrast, the printing controller 100 according to this embodiment can detect contamination on the transparent member 19a and execute processing that takes this detection result into consideration.

Specifically, the window inspection unit 151 detects contamination on the transparent member 19a by identifying the distance measuring light caused by the reflected light from the transparent member 19a among the distance measuring light received by the light receiving part 52. Then, this window inspection unit 151 outputs the detection result, displays it on the display unit 301 or the like, or stores it in the storage unit 303 as an operation log along with other data. The detection result by the window inspection unit 151 is an example of “maintenance information”in this embodiment.

As mentioned earlier, the transparent member 19a is arranged at a reference position where the optical path length between it and the emission part 51 is known. Since the optical path length is known, the position where the distance measuring light reflected by the surface of the transparent member 19a forms a peak can be predicted in advance.

Therefore, the window inspection unit 151 can detect contamination on the transparent member 19a based on the light reception status at the light receiving position corresponding to the aforementioned reference position among the light receiving positions of the distance measuring light at the light receiving part 52.

For example, the window inspection unit 151 can determine that the reflected light is caused by contamination of the transparent member 19a if the position where the reflected light forms a peak on the light receiving surface of the light receiving element 52a falls within a predetermined range. The predetermined range used for this determination should be a numerical range that includes the light receiving position corresponding to the reference position.

In this way, the window inspection unit 151 can identify the reflected light reflected by the transparent member 19a based on the light receiving position of the reflected light. In addition, the window inspection unit 151 can also determine the degree of contamination on the transparent member 19a based on the amount of received reflected light.

Specifically, the window inspection unit 151 can determine the degree of contamination on the transparent member 19a based on the amount of received light at the reference light reception position X2. In detail, the window inspection unit 151 can compare the amount of received light at the reference light reception position X2 with a predetermined threshold value T, and determine that the transparent member 19a is contaminated if the amount of received light exceeds the threshold value T (refer to FIG. 16(c)).

As shown in the usage example in FIG. 8, the maintenance process can be used to create an operation log as maintenance information, along with other data related to the operation of the laser marking system S. The maintenance process contributes to the collection of maintenance information.

### Other Pre-printing Processes

In addition, the pre-printing process may include one or more of the imaging process executed by the log storage unit 152 and the code reading process executed by the code reading unit 153.

In the imaging process, the log storage unit 152 controls the imaging units 62 and 7 to generate a captured image Pw′ of the printing target W′ before the printing process. The log storage unit 152 stores the generated captured image Pw′ in the storage unit 101 of the printing controller 100, the storage unit 303 of the setting device 300, etc.

In the code reading process, the code reading unit 153 controls the imaging unit 62, 7 to generate a captured image Pw′ of the printing target W′ before the printing process. The code reading unit 153 determines whether or not a two-dimensional code is included in the captured image Pw′ based on the generated captured image Pw′.

Then, if a two-dimensional code is included in the captured image Pw′, the code reading unit 153 reads the two-dimensional code and acquires the information encoded by that two-dimensional code. The code reading unit 153 utilizes the acquired information for various other processes, or stores it along with the captured image Pw′ obtained by the imaging process in the storage unit 101 of the printing controller 100, the storage unit 303 of the setting device 300, etc.

As shown in the usage example in FIG. 8, the imaging process and code reading process can be used, for example, to create an operation log of the laser marking system L. The code reading process can read, as a 2D code, for example, a lot number or serial number previously assigned to the printing target W′. By reading such a 2D code, it can be used for the operation of the laser marking system L. However, using the code reading process for the operation of the laser marking system L is not essential.

Furthermore, when a two-dimensional code is used for the printing pattern Pm, by performing a code reading process, it can also be used for double printing prevention, similar to other pre-printing processes.

### Basic Concept of Post-Printing

Process-The post-printing process is a process performed by the printing controller 100 after the printing process. The operation performed by the printing head 1 through the post-printing process can be called “post-printing operation”.

In the post-printing process, the printing controller 100 controls at least one of the imaging units 62, 7 and the distance measuring unit 5, as exemplified by “printing confirmation” and “window inspection” in FIG. 8. It also acquires information related to the printing pattern Pm formed by the printing process executed through the window inspection unit 151, log storage unit 152, code reading unit 153, and print verification unit 154.

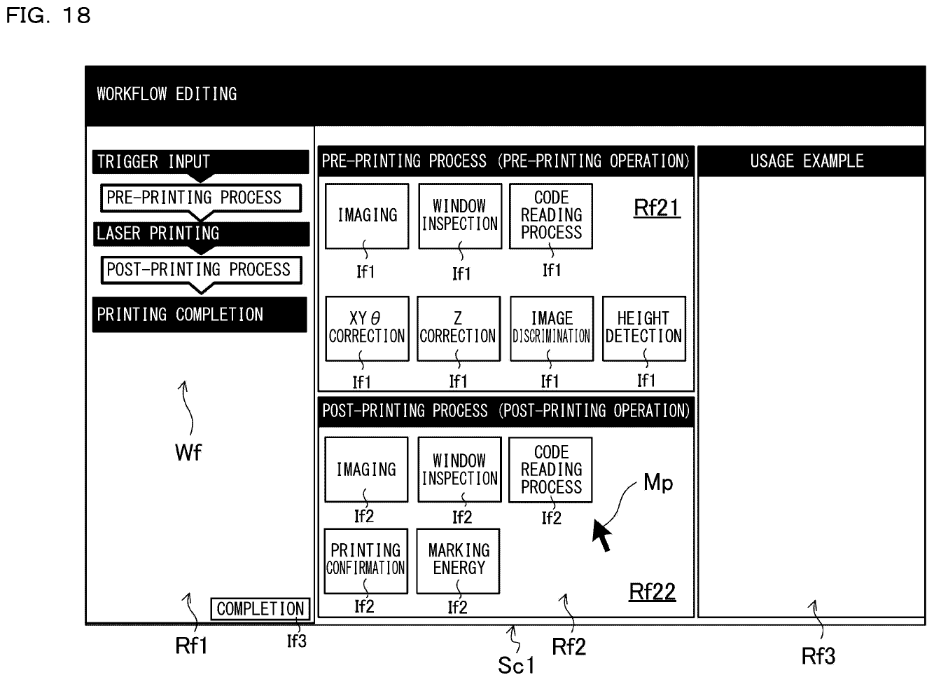

Here, the post-printing process includes, as exemplified in FIG. 8, a printing confirmation process, a window inspection as a maintenance process, an output monitoring process, an imaging process, and a code reading process. As shown in FIGS. 18 to 20, the output monitoring process may be referred to or illustrated as “marking energy”, the imaging process may be simply referred to or illustrated as “imaging”, and the printing confirmation process may be simply referred to or illustrated as “printing confirmation”.

Here, the printing confirmation process and the imaging process both correspond to a process of inspecting the workpiece W, especially the printing target W′, on which the printing pattern Pm has been printed by the printing process, based on the captured image Pw′ obtained through the imaging units 62 and 7. These processes are examples of “inspection process” in this embodiment.

The detailed settings for the post-printing process are determined by the post-printing process setting unit 304e before or after editing the workflow Wf. The determined content constitutes an element of the print settings and is transferred from the setting device 300 to the printing controller 100, after which it is stored in the storage unit 101 of the printing controller 100.

In the printing confirmation process, the printing confirmation unit 154 controls the imaging units 62 and 7 to generate a captured image Pw′ of the printing target W′ after the printing process. The printing confirmation unit 154 also determines, based on the generated captured image Pw′, whether the preset printing pattern Pm is actually marked on the printing target W′. This determination may be automatically made by the printing controller 100 or the setting device 300, or the user may be allowed to make the determination by displaying the captured image Pw′ on the display unit 301. As shown in the usage example in FIG. 8, the printing confirmation process can be used for determining the printing quality.

In the former case, an image (reference image) showing the desired printing pattern Pm may be stored in advance in the printing controller 100. In this case, the printing controller 100 may determine the processing quality of the printing pattern Pm′ by comparing the reference image with the captured image Pw′. Additionally, the reference image may be an image generated from the setting surface R2 on which the printing pattern Pm is arranged.

The details of window inspection are similar to those of the pre-printing process. In other words, in this embodiment, window inspection can be included in at least one of the pre-printing process and the post-printing process.

In the output monitoring process, the printing controller 100 monitors the transition of marking energy based on the detection signal from the power monitor 23. The monitoring result can be used to create an operation log as maintenance information along with other data related to the operation of the laser marking system L. The output monitoring process contributes to the collection of maintenance information.

In the imaging process, the log storage unit 152 controls the imaging units 62 and 7 to generate a captured image Pw′ of the printing target W′ after the printing process. The log storage unit 152 stores the generated captured image Pw′ in the storage unit 101 of the printing controller 100, the storage unit 303 of the setting device 300, etc.

In the code reading process, the code reading unit 153 controls the imaging unit 62, 7 to generate a captured image Pw′ of the printing target W′ before the printing process. The code reading unit 153 determines whether or not a two-dimensional code is included in the captured image Pw′ based on the generated captured image Pw′.

Then, if a two-dimensional code is included in the captured image Pw′, the code reading unit 153 determines the quality (grade) of that two-dimensional code. The determination of the grade of the two-dimensional code can be performed based on the evaluation standards for printing quality for two-dimensional codes established based on ISO/IEC, etc. The code reading process in the post-printing process becomes especially effective when a two-dimensional code is used for the printing pattern Pm. As shown in the usage examples in FIG. 8, the code reading process in the post-printing process can be used for determining the printing quality and monitoring the printing content.

### Configuration Related to Workflow Editing

Hereafter, for the sake of brevity, the process consisting of at least one of pre-printing process and post-printing process will be referred to as “pre-post printing process”. Each process constituting the pre-post printing process is as explained with reference to FIG. 8 and others.

The laser marking apparatus L according to this embodiment is configured to include a storage unit 303 as an order information storage unit and a workflow editor 304c to improve user convenience related to the workflow Wf. The storage unit 303 stores order information Io associated with each of the pre-printing and post-printing processes. The workflow editor 304c edits the workflow Wf that defines a series of processes including the printing process. These elements will be explained with reference to specific examples.

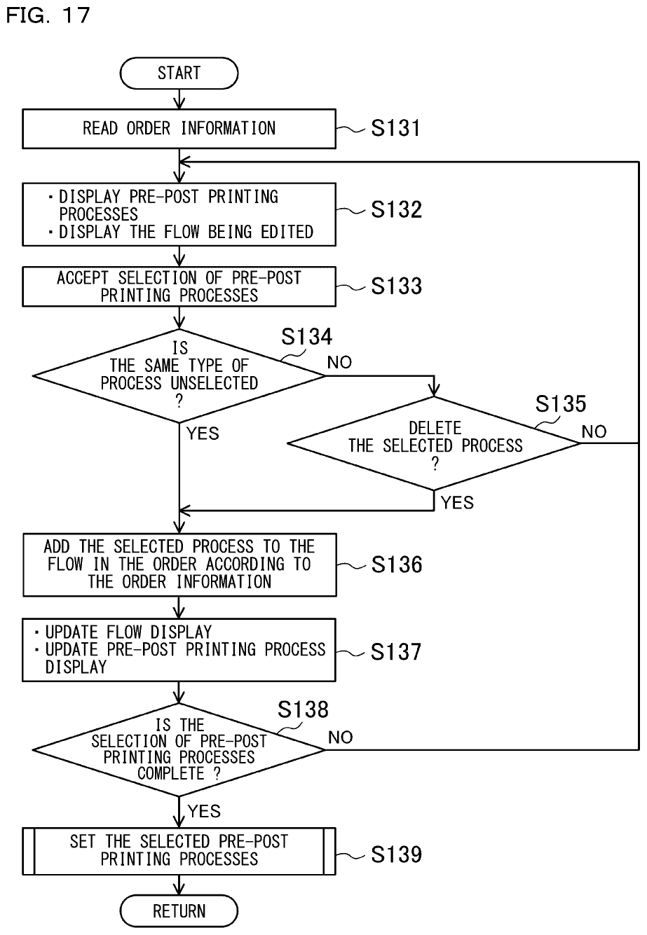

FIG. 17 is a flowchart illustrating an example of the editing procedure for the workflow Wf. FIGS. 18 to 20 are diagrams illustrating examples of the editing screen for the workflow Wf. When the control process proceeds to step S13 in FIG. 9, the setting device 300 executes the processes shown in FIG. 17 in order, starting from step S131.

First, in step S131, the processing unit 304 reads the order information Io from the storage unit 303. This order information Io defines the execution order of each process that constitutes the pre-post printing process.

As illustrated in FIG. 8, the order information Io regarding the pre-printing process is defined such that each process is executed in the order of imaging process, window inspection, XYθ correction or image discrimination, height correction or height detection, and code reading process, from the earliest process to the latest process in the execution order. If, for example, window inspection is not selected for the pre-printing process, XYθ correction or image discrimination will begin after the execution of the imaging process.

Furthermore, as evident from the aforementioned regulations, XYθ correction and image discrimination are defined to have the same execution order. In other words, XYθ correction and image discrimination are set as processes that can be selectively chosen.

Similarly, height correction and height detection are defined to have the same execution order as each other. In other words, height correction and height detection are set as processes that can be selectively chosen.

Furthermore, as indicated in the aforementioned description, the order information Io is defined to include the execution order of window inspection as a maintenance process. Specifically, the order information Io related to this embodiment is defined, as shown in FIG. 8, so that the window inspection is executed before the first to fourth pre-printing processes. As an example, in this embodiment, the window inspection is performed before all of the first pre-printing process, second pre-printing process, third pre-printing process, and fourth pre-printing process.

Furthermore, as exemplified in FIG. 8, the order information Io related to the post-printing process is defined such that each process is executed in the order of imaging process, printing confirmation process, code reading process, window inspection, and output monitoring process, from the earliest to the latest execution order. If, for example, the code reading process is not selected for the post-printing process, the window inspection will start after the execution of the printing confirmation process.

As shown in FIG. 8, the window inspection as a maintenance process and the output monitoring process are defined to be executed after the imaging process and the printing confirmation process as inspection processes, and the code reading process.

The order information Io can be configured by associating each pre-post printing process with execution order, priority, etc. The order information Io is, for example, information stored in advance by the manufacturer at the time of factory shipment.

In the subsequent step S132, the processing unit 304 displays on the display unit 301 the pre-post printing processes stored in the storage unit 303 and associated with the order information Io. The processing unit 304, in addition to the pre-post printing processes, displays on the display unit 301 the workflow Wf being edited by the workflow editor 304c.

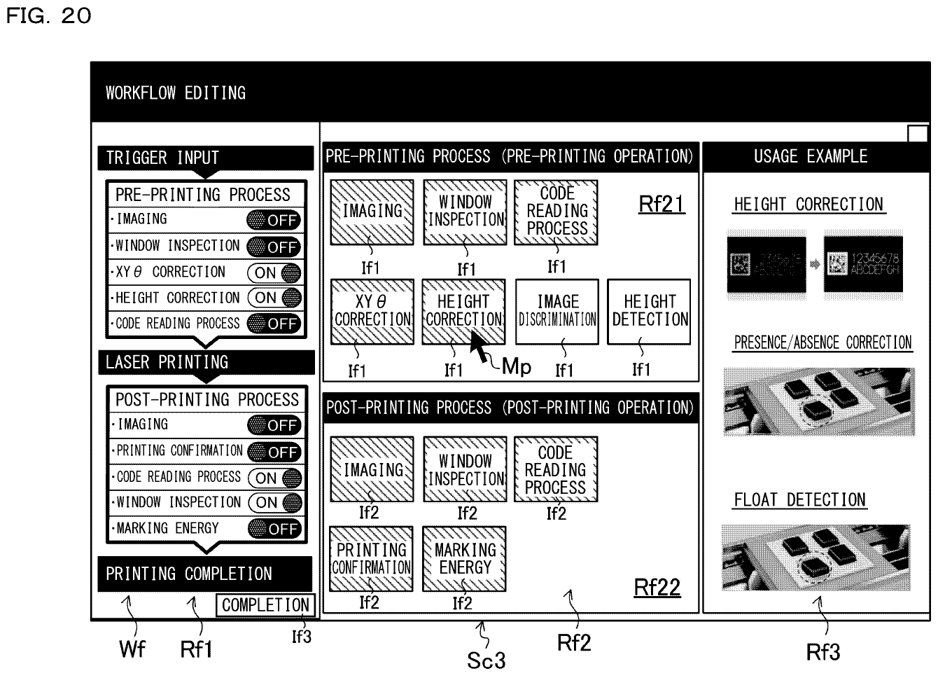

Here, FIG. 18 is a figure illustrating an example of a display screen Sc1 in a state where pre-post printing processes are unselected, and FIG. 19 is a figure illustrating an example of a display screen Sc2 in a state where all processes except height correction, image discrimination, and height detection among the pre-post printing processes are selected. FIG. 20 is a figure illustrating an example of a display screen Sc3 in a state where all processes except image discrimination and height detection among the pre-post printing processes are selected. All of these screens can be displayed on the display unit 301. Additionally, the various GUIs displayed on these screens are controlled by the GUI control unit 304f of the processing unit 304.

As shown in FIGS. 18, 19, and 20, the display unit 301 displays a flow display area Rf1 and a flow selection area Rf2. The flow display area Rf1 visualizes and displays the structure of the workflow Wf in a state reflecting the execution order of pre-post printing processes for the printing process (i.e., the execution order defined by the order information Io). The flow selection area Rf2 is displayed independently of the flow display area Rf1, lists the pre-post printing processes, and accepts user input for selecting pre-post printing processes.

The workflow Wf displayed in the flow display area Rf1 is a workflow that includes the currently selected pre-post printing process. As shown by comparing FIG. 8 and FIGS. 19-20, the displayed workflow is arranged in the execution order specified by the order information Io, including the before-and-after relationship with the printing process (laser marking). As shown in the example figure, the flow display area Rf1 displays the names of a series of processes including the printing process in the order of execution.

The flow selection area Rf2 is composed of a first selection area Rf21 that displays a list of pre-printing processes, and a second selection area Rf22 that is displayed independently of the first selection area Rf21 and displays a list of post-printing processes.

In the first selection area Rf21, a first interface If1 corresponding to each process constituting the pre-printing process is arranged. Multiple first interfaces If1 are all configured as GUIs that accept user input through the operation unit 302, such as mouse operations.

In the second selection area Rf22, a second interface If2 corresponding to each process constituting the post-printing process is arranged. Multiple second interfaces If2 are all configured as GUIs that accept user input through the operation unit 302, such as mouse operations.

As shown in FIGS. 18, 19, and 20, the GUI corresponding to the pre-post printing processes incorporated in the workflow Wf is visualized in a different display mode compared to the GUI corresponding to other pre-post printing processes not incorporated in the workflow Wf. The display modes to be differentiated include, in addition to the display color of the GUI as shown in the example, the presence or absence of blinking of each GUI, and the display size.

In addition, as shown in FIG. 18, FIG. 19, and FIG. 20, the display unit 301 displays a use case display area Rf3 independent of the flow display area Rf1 and the flow selection area Rf2. The use case display area Rf3 is an area for displaying use cases of each process.

For example, as shown in FIG. 19, assume that the mouse pointer Mp has been moved onto the first interface If1 corresponding to “height correction”. In this case, the usage example display area Rf3 will display images showing “height correction”, “presence/absence detection”, and “float detection”as explained with reference to FIG. 8.

The user selects the necessary pre-printing and post-printing processes by referring to various display contents on the display unit 301. Specifically, following step S132, in step S133, the input receiver 304g accepts the selection of pre-printing and post-printing processes to be included in the workflow Wf in response to user input, from the pre-printing and post-printing processes (for example, the first and second interfaces If1, If2) displayed on the display unit 301.

In the case of the illustrated example, as shown in FIG. 19, when the user performs a user input such as a click operation with the mouse pointer Mp moved onto the first interface If1 corresponding to “height correction”, the input receiver 304g accepts the selection of “height correction”as a pre-post printing process to be included in the workflow Wf.

Here, as exemplified in step S134 and step S135, the workflow editor 304c of this embodiment is configured to selectively add either XYθ correction or image discrimination to the workflow Wf when the input receiver 304g accepts the selection of both XYθ correction and image discrimination.

The aforementioned determination is made, for example, when either XYθ correction or image discrimination is incorporated into the workflow Wf, and the other of XYθ correction and image discrimination is further selected.

Similarly, as exemplified in steps S134 and S135, the workflow editor 304c of this embodiment is configured to selectively add either height correction or height detection to the workflow Wf when the input receiver 304g accepts the selection of both height correction and height detection.

The aforementioned determination is made, for example, when either height correction or height detection is incorporated into the workflow Wf, and the other of height correction and height detection is further selected.

Specifically, in step S134 following step S133, the workflow editor 304c determines whether a process of the same type as the process selected in step S133 is in an unselected state (a state not incorporated into the workflow Wf).

In this embodiment, XYθ correction and image discrimination are in a relationship of the first type of similar processes, while height correction and height detection are in a relationship of the second type of similar processes. In other words, when any pre-post printing process other than these four processes is selected, the determination in step S134 inevitably becomes YES in this embodiment.

If the determination in step S134 is YES, the processing unit 304 advances the control process to step S136. If the determination in step S134 is NO, the processing unit 304 advances the control process to step S135.

In the example of FIG. 19, in step S134, the workflow editor 304c determines whether a process of the same type as “height correction” selected in step S133, namely “height detection”, is in an unselected state or not. Since “height detection” is in an unselected state, the determination in step S134 becomes YES, and the control process proceeds to step S136.

In step S135, the workflow editor 304c confirms with the user whether to delete the same type of process (a process already selected in the workflow Wf) from the workflow Wf in order to add the process selected in step S133 to the workflow Wf. This confirmation can be done through a dialog on the display unit 301. If the input receiver 304g receives an affirmative user input to delete (Step S135: YES), the workflow editor 304c deletes the same type of process from the workflow Wf.

On the other hand, when the input receiver 304g accepts a user input denying deletion (Step S135: NO), the workflow editor 304c returns the control process to Step S132 and cancels the selection accepted in Step S133.

In step S136, the workflow editor 304c adds the pre-post printing process, for which the input receiver 304g has accepted the selection, to the workflow Wf including the printing process in the order corresponding to the order information Io associated with that pre-post printing process.

In the subsequent step S137, the workflow editor 304c updates both the display content of the workflow Wf in the flow display area Rf1 and the display content of the pre-post printing process in the flow selection area Rf2 (especially, the display mode of the GUI corresponding to the selected process).

In the example of FIG. 19, as a result of executing the processes of step S136 and step S137, the screen on the display unit 301 will transition from the display screen Sc2 of FIG. 19 to the display screen Sc3 exemplified in FIG. 20. As shown by comparing the workflow Wf in FIG. 19 with the workflow Wf in FIG. 20, it can be observed that height correction has been added between the XYθ correction and the code reading process without the user applying any special settings.

As shown in FIG. 19 and FIG. 20, a GUI (fourth interface If4) labeled “ON” or “OFF” is displayed on the side of the screen for each process incorporated in the workflow Wf. By applying user input to these, the execution possibility of the pre-post printing process corresponding to the fourth interface If4 can be switched.

The fourth interface If is a GUI for switching the execution possibility of each pre-post printing process constituting the workflow Wf displayed in the flow display area Rf1, and is an example of the “switching section”in this embodiment.

The input receiver 304g accepts user input for selecting the execution possibility of each process through the fourth interface If4. The printing controller 100 executes the printing process and the pre-post printing process to reflect the user input through the fourth interface If4.

Subsequently, in step S138 following step S137, the workflow editor 304c determines whether the selection of pre-post printing processes (editing of workflow Wf) has been completed. This determination may be configured to be YES when the input receiver 304g accepts user input for a specific GUI, such as the third interface If3 as a GUI exemplified in FIGS. 18 to 20. The configuration of step S138 is not particularly limited.

If the determination in step S138 is YES, the processing unit 304 advances the control process to step S139. In this case, the processing unit 304 executes the settings of each selected pre-post printing process. If the determination in step S138 is NO, the processing unit 304 returns the control process to step S132.

The following explains the main parts of the process performed in step S139.

### Setting of Pre-Post Printing Process

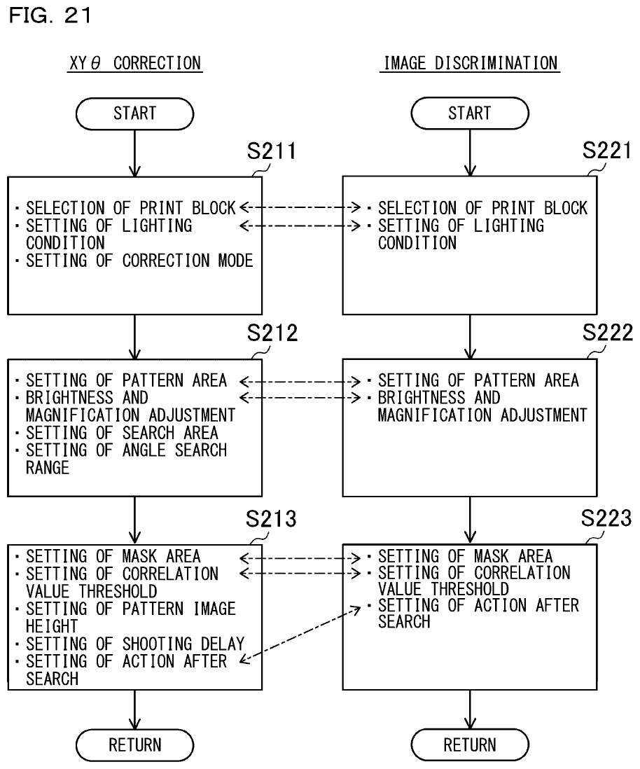

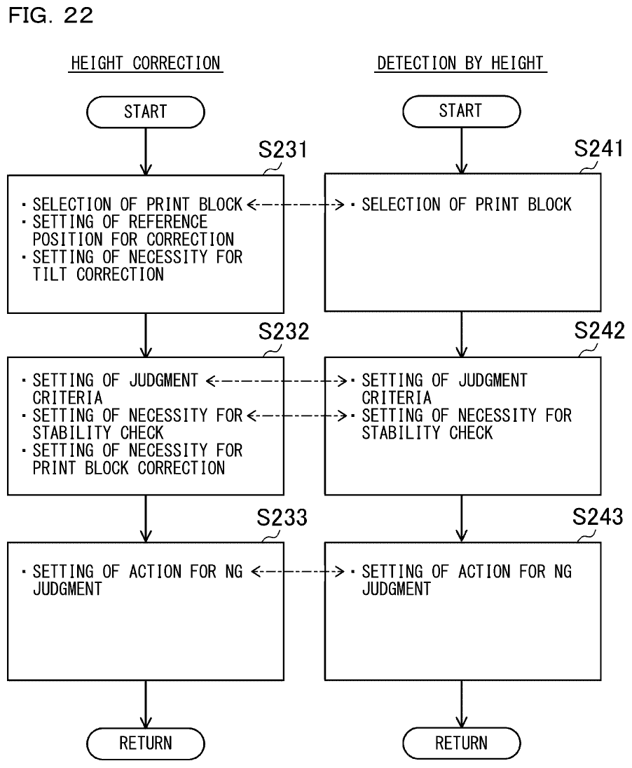

FIG. 21 is a diagram comparing the setting procedures for XYθ correction and image discrimination. FIG. 22 is a diagram comparing the setting procedures for height correction and height detection. Both FIG. 21 and FIG. 22 are structured as flows focusing on the setting items in each process.

Specifically, the left figure in FIG. 21 is a flowchart illustrating an example of the setting procedure performed for XYθ correction, and the right figure in FIG. 21 is a flowchart illustrating an example of the setting procedure performed for image discrimination.

On the other hand, the left figure in FIG. 22 is a flowchart illustrating an example of the setting procedure performed for height correction, and the right figure in FIG. 22 is a flowchart illustrating an example of the setting procedure performed for height detection.

Here, the double-headed arrows added to FIG. 21 and FIG. 22 indicate that the setting items are common to the processes exemplified on the left and right. Additionally, the steps exemplified in FIG. 21 and FIG. 22 are determined with the aim of making it easier to compare the setting items, and are not limited to the steps shown in the figure examples.

Although not illustrated, various settings are made through various GUIs displayed on the display unit 301. When a user selects or inputs a specific item, the corresponding user input is accepted by the input receiver 304g, and the pre-printing process setting unit 304d executes the setting corresponding to that user input.

### XYθ Correction and Image Discrimination

In step S211 of the process related to the setting of XYθ correction, the pre-printing process setting unit 304d selects the printing pattern Pm to be the target of correction by XYθ correction, specifically, the printing block Pb corresponding to that printing pattern Pm. The printing block Pb selected here corresponds to the printing block Pb that is the target of the “correction of printing pattern Pm related to XY misalignment” mentioned earlier.

At the same step S211, the pre-printing process setting unit 304d sets the lighting condition (selection of illumination 18) used for generating the captured images Pw, Pw′ for pattern search.

In the same step S211, the pre-printing process setting unit 304d sets one correction mode from among multiple correction modes. The multiple correction modes are set such that the number of pattern areas Rp used for one print block Pb differs from each other. For example, when two pattern areas Rp are used for one print block Pb, the correction accuracy in the rotational direction can be improved.

In the subsequent step S212, the pre-printing process setting unit 304d executes the setting of the pattern area Rp, brightness and magnification adjustment, setting of the search area Rs, and setting of the angle search range.

Here, brightness and magnification adjustment refers to the setting that determines the brightness and magnification during imaging by the imaging units 62 and 7. The angle search range refers to the range of rotation angles (upper and lower limits of rotation angle in the XY plane) of the pattern area Rp during pattern search.

In the subsequent step S213, the pre-printing process setting unit 304d executes the setting of the mask area, the setting of the correlation value threshold, the height setting of the pattern image Pp, the setting of the shooting delay, and the setting of the post-search operation.

A mask area is an area for masking information that could potentially interfere with pattern search, such as patterns (e.g., serial numbers) pre-processed on each workpiece W. By masking such information, a higher accuracy pattern search can be realized.

The correlation value threshold is the lower limit of the correlation value that serves as an index for pattern search. For example, if the correlation value obtained during the actual pattern search is high and above the aforementioned lower limit, it can be determined that the pattern search has succeeded (an area identical to the pattern area Rp has been discovered). On the other hand, if the correlation value obtained during the pattern search is below the aforementioned lower limit, it can be determined that the pattern search has failed (an area identical to the pattern area was not discovered).

The height setting of the pattern image Pp is a setting item for pre-setting the height of the pattern image Pp. This setting item may be input by the user themselves, or it may be set to be acquired through the distance measuring unit 5 and the distance detector 103.

The imaging delay indicates the waiting time from when the workpiece W, which is the printing target, is conveyed (for example, from when the trigger signal receiver 120 accepts the trigger signal) until the imaging necessary for pattern search begins during the operation of the laser marking system S.

The post-search operation is an action to be performed when a predetermined pattern area Rp is not found or when the workpiece W itself is not found. The setting items related to the post-search operation include a setting for one of multiple NG conditions.

Multiple NG conditions include failure in pattern search (search failure) and success in pattern search (search success). The former condition is used, as mentioned earlier, to set actions to be taken when a predetermined pattern area Rp is not found or when the workpiece W itself is not found. The latter condition contributes to setting actions to be taken when a surface condition or pattern image Pp of a workpiece W′ that should not exist is found, such as in double printing prevention.

The setting items related to post-search operations further include settings for processes to be performed when NG conditions are established. Such processes include multiple processes. The multiple processes include: not outputting both error and warning (without outputting error/warning), outputting a warning (warning output), and outputting an error and interrupting laser marking (error output).

The setting items related to post-search operations further include settings for other processes to be performed when NG conditions are established. Such processes include multiple processes. The multiple processes include continuing laser marking (printing continuation) and interrupting laser marking (printing interruption). In this embodiment, when “error output” is selected, “printing interruption” is automatically selected. Determinations such as NG condition judgment and determinations related to “printing interruption” are examples of “determination of feasibility of printing process”in this disclosure.

On the other hand, the setting items related to image discrimination are all included in XYθ, as exemplified in steps S221, S222, and S223 in the right figure of FIG. 21. “Setting of correction mode”, “Setting of search area”, “Setting of angle search range”, “Height setting of pattern image Pp”, and “Setting of shooting delay” are setting items specific to XYθ and are excluded from the setting items in image discrimination.

The setting items determined through each step in FIG. 21 constitute an element of the printing settings, and after being transferred from the setting device 300 to the printing controller 100, they are stored in the storage unit 101 of the printing controller 100.

### Height Correction and Height Detection

In step S231 of the process related to the setting of height correction, the pre-printing process setting unit 304d selects the printing pattern Pm to be the correction target for height correction, specifically, the printing block Pb corresponding to that printing pattern Pm.

In the same step S231, the pre-printing process setting unit 304d sets the origin (reference position) for the height of the workpiece W. This reference position may be set as the height of a specific print block Pb if there are multiple print blocks Pb, or the height of each print block Pb may be individually set as the reference position, or a specific arbitrary coordinate defined by the user may be set as the reference position.

In the same step S231, the pre-printing process setting unit 304d sets (setting of necessity for tilt correction) one correction mode from among multiple correction modes. The multiple correction modes are composed of a first correction mode that performs only Z-coordinate correction in height correction, and a second correction mode that performs tilt correction in addition to Z-coordinate correction.

In the subsequent step S232, the pre-printing process setting unit 304d executes the setting of judgment criteria, the setting of necessity for stability check, and the setting of necessity for print block correction.

Here, the judgment index indicates either the upper limit or the lower limit of the measured distance (height) value. The stability check is a process to verify the reliability of the measurement. To explain in more detail, it is a process that verifies the reliability of the measurement based on how many times the distance (height) measurement, which is performed multiple times, was successful (the number of successful attempts or the frequency of success within that measurement). For example, the stability check related to this embodiment can be configured to determine that “the reliability of the measurement is ensured” and allow the correction of the print block when the number of successful measurements or the frequency of success exceeds a predetermined threshold. Additionally, by setting the necessity for print block correction, it is possible to set whether to only perform distance measurement for the print block Pb selected in step S231, or to execute the correction of the print pattern Pp based on that measurement result.

In the subsequent step S233, the pre-printing process setting unit 304d executes the setting of action for NG judgment. The action for NG judgment is an operation performed when the distance measurement result is outside the range of the judgment criteria set in step S232 (when the NG judgment is established).

The setting items related to the action for NG judgment include settings for the process to be performed when an NG judgment is established. Such processes include multiple processes. The multiple processes include: not outputting both error and warning (no error/warning output), outputting a warning (warning output), and outputting an error and interrupting laser printing (error output).

The setting items related to the action for NG judgment further include settings for other processes to be performed when the NG condition is established. Such processes include multiple processes. The multiple processes include continuing laser printing (continue printing), continuing laser printing after performing height correction (correct and continue printing), and interrupting laser printing (interrupt printing). In this embodiment, when “error output” is selected, “interrupt printing” is automatically selected. The determination of NG conditions and other determinations related to “interrupt printing” are examples of “determination of whether to execute the printing process”in this disclosure.

On the other hand, the setting items related to height detection are included in the height correction, as exemplified in steps S241, S242, and S243 in the right figure of FIG. 22. “Setting of correction mode”, “Setting of reference position for correction”, and “Setting of necessity for tilt correction” are setting items specific to height correction and are excluded from the setting items for height detection.

The setting items determined through each step in FIG. 22 constitute another element of the print settings, and after being transferred from the setting device 300 to the printing controller 100, they are stored in the storage unit 101 of the printing controller 100.

### 6. Operation of Laser Marking Apparatus

Referring again to step S3 in FIG. 7, the operation procedure of the laser marking apparatus L based on the processing by the workflow editor 304c will be explained. First, in step S31 of FIG. 7, in step S301, when a trigger signal is input to the printing controller 100 from the PLC 402 or the like, a new workpiece (correction target) W′ different from the workpiece (setting target) W used for various settings including the pattern area Rp is conveyed.

In the subsequent step S32, the printing controller 100 executes the pre-printing process through the printing head 1. In the subsequent step S33, the printing controller 100 executes the printing process through the printing head 1. In the subsequent step S34, the printing controller 100 executes the post-printing process through the printing head 1. In steps S32 to S34, the printing controller 100 executes a series of processes including the printing process.

Here, in steps S32 to S34, the printing controller 100 executes the printing process and the pre-post printing processes added to the workflow Wf by the workflow editor, according to the order defined by the workflow Wf. In the case of the workflow Wf shown in FIG. 21, XYθ correction and height correction are executed in the pre-printing process, and code reading process and window inspection are performed in the post-printing process.

If the pre-printing process is unselected, the process in step S32 will be omitted, and if the post-printing process is unselected, the process in step S34 will be omitted.

When the series of processes exemplified in steps S32 to S34 is completed, the printing controller 100 advances the control process to step S35. In step S35, the printing controller 100 determines whether the operation of the laser marking apparatus L has ended or not based on the condition settings transferred from the setting device 300, input signals from the PLC 402, etc. If this determination is YES, the printing controller 100 ends the flow shown in FIG. 7.

On the other hand, if the determination in step S35 is NO, the printing controller 100 waits until it becomes possible to accept a trigger signal again (step S36). When it becomes possible to accept a trigger signal, the printing controller 100 returns the control process to step S31.

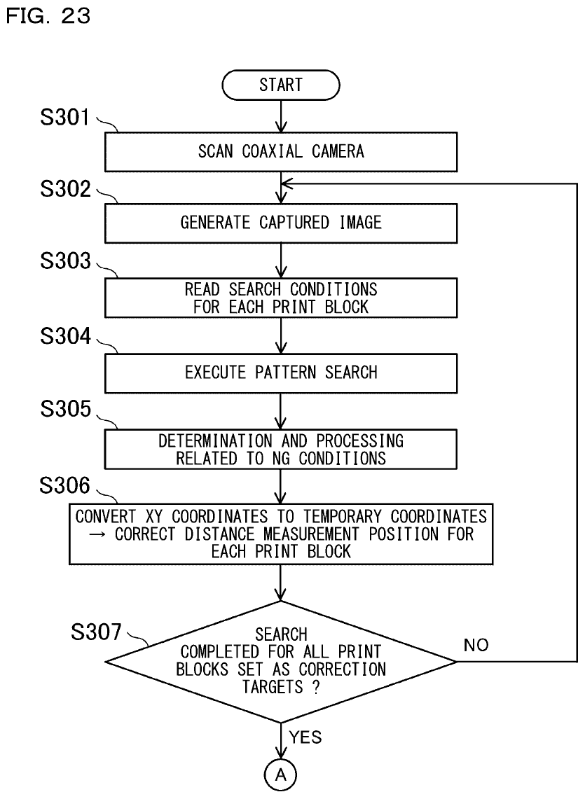

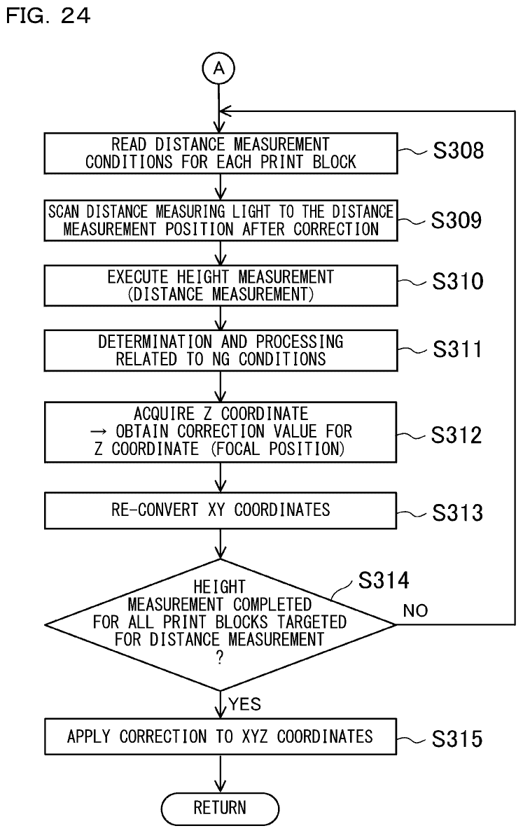

The following describes specific examples of pre-printing processes based on the workflow Wf, with reference to FIG. 23 and FIG. 24. FIG. 23 and FIG. 24 illustrate examples of pre-printing processes performed when multiple pre-printing processes are added to the workflow Wf, but only XYθ correction and height correction are set to “ON” (as in the case of FIG. 21).

First, in step S301 of FIG. 23, the printing controller 100 operates the laser light scanner 4. The printing controller 100 directs the imaging optical axis A4 of the coaxial camera 62 towards the location where the workpiece W is expected to be transported when the conveyor line is activated. However, if the wide-area camera 7 is used instead of the coaxial camera 62, step S301 becomes unnecessary.

Subsequently, as shown in FIG. 1, upon input of a trigger signal, a new workpiece W′ different from the workpiece W used for various settings including the pattern area Rp is conveyed below the printing head 1.

Here, the print block Pb corresponding to the print pattern Pm is set by a coordinate system defined on the setting surface R2. Therefore, if the printing target W′ experiences an XY misalignment relative to the setting target W, there is a possibility that the print pattern Pm cannot be formed at the desired position on the printing target W'.

Therefore, the printing controller 100 executes pattern search and XYθ correction based on the search result for the aforementioned new workpiece W', which is the printing target W'.

Specifically, in step S302 following step S301, the printing controller 100 generates a captured image Pw′ via the coaxial camera 62, and displays the generated captured image Pw′ superimposed on the setting surface R2 (refer to FIG. 12).

Then, in step S303 following step S302, the printing controller 100 reads the condition settings (search conditions) defined as shown in FIG. 21 for each of the print blocks Pb selected in step S211 of FIG. 21.

In the subsequent step S304, the printing controller 100 executes the pattern search configured as described above. By executing the pattern search, XY misalignment of the pattern area Rp is detected between the initial workpiece W, which is set as the setting target W, and the new workpiece W′, which is set as the printing target W′ and is newly conveyed during device operation, despite being of the same type or model as the initial workpiece.

In the subsequent step S305, the printing controller 100 performs the determination of whether the NG condition is established or not, as explained with reference to FIG. 21. When the NG condition is established, the printing controller 100 executes the process that has been set in advance.

Although omitted in FIG. 21, the setting information related to pattern search includes the relative positional relationship V1 between the pattern area Pr and the print block Pb to be corrected (see FIG. 12). Therefore, once the position Sr of the pattern area Pr on the printing target W′ is identified, it becomes possible to determine the print block Pb′ and the printing pattern Pm′ corresponding to the position Sr based on the relative positional relationship V1.

However, at this point, the positional and orientation deviation (Z misalignment) in the Z direction between workpieces W and W′ has not been resolved. When Z misalignment occurs (when the height and tilt of workpiece W change), XY misalignment will further occur due to factors such as the expansion of the field of view in the coaxial camera 62.

Therefore, correcting the position of the print block Pb based only on the detection results obtained in step S304 would result in residual XY direction position misalignment caused by the height of the printing target W′.

Therefore, in step S306 following step S305, the XYθ processing unit 131 provisionally corrects the XY misalignment of the printing target W′ based on the detection result of step S304.

Specifically, the XYθ processing unit 131 shifts the printing coordinate system defined on the setting surface R2 in a direction that cancels out the XY misalignment detected by the XYθ processing unit 131. This allows for the conversion from the initially set XY coordinates to temporary XY coordinates (temporary coordinates) where the XY misalignment is at least partially canceled out.

Then, by converting the XY coordinates to temporary coordinates, the position of the print block Pb, which was set using the XY coordinates before conversion, will move along with the conversion to temporary coordinates.

On the other hand, although omitted in FIG. 22, the setting information related to height correction includes coordinate information of the distance measurement position I associated with each print block Pb. Therefore, when converting the XY coordinates to temporary coordinates in step S305, the distance measurement position I also moves along with the movement of the print block Pb.

In other words, the XYθ processing unit 131 generates the distance measurement position I′ on the printing target W′ by correcting the distance measurement position I set by the pre-printing process setting unit 304d (see FIG. 12).

Thus, the XYθ processing unit 131 is configured to correct the position of the print block Pb and the distance measurement position I, respectively, between the setting target W and the printing target W′, based on the detection result of the XY misalignment.

Then, in step S307 following step S306, the printing controller 100 determines whether the pattern search has been completed for all print blocks Pb that were designated as correction targets for the print pattern Pm related to XY misalignment. If this determination is YES, it proceeds to step S308 in FIG. 24, while if it is NO, it returns to step S302.

In the subsequent step S308, the printing controller 100 reads the condition settings (distance measurement conditions) determined as shown in FIG. 22 for each of the print blocks Pb selected in step S231 of FIG. 22.

In the subsequent step S309, the head control unit 102 controls the laser light scanner 4 so that the distance measuring light is irradiated at the corrected distance measurement position I′. This enables the measurement of the distance from the printing head 1 to the distance measurement position I′, which reflects the conversion to the temporary coordinate system.

In the subsequent step S310, the distance measurement unit 103 operates the distance measuring unit 5. At this time, the emission unit 51 measures the distance from the laser marking apparatus L to the surface of the marking target W′. The light receiving unit 52 receives the distance measuring light that is reflected on the surface of the marking target W′ and returns through the laser light scanning unit 4. This measures the distance from the printing head 1 to the distance measurement position I′ corrected by the XYθ processing unit 131, and consequently, the height of the marking target W′ at that distance measurement position I′.

In the subsequent step S311, the printing controller 100 performs the determination of whether the NG condition is established or not, as explained with reference to FIG. 22. When the NG condition is established, the printing controller 100 executes the process that has been set in advance.

In the subsequent step S312, the Z processing unit 132 acquires the Z coordinate of the workpiece W′ at the distance measurement position I′ based on the measurement result from the distance measuring unit 103, and detects the Z-axis misalignment of the printing target W′. This Z-axis misalignment can be detected based on the difference between the acquired Z coordinate and the reference height (coordinate of the origin) in the Z direction.

The Z processing unit 132 acquires the control parameters for the focal adjustment unit 33 based on the Z-axis misalignment of the printing target W′. The control parameters acquired here correspond to the parameters (Z coordinate, correction value for focal position) used by the focal adjustment unit 33 when correcting the focal position.

The parameters thus obtained are used to control the focal adjustment unit 33 by the head control unit 102 before executing laser marking on the printing target W′. In other words, the focal adjustment unit 33 of this embodiment can adjust the focal position based on the measurement result of the distance measuring unit 103, with the distance measurement position I corrected by the XYθ processing unit 131, prior to irradiating the printing laser light onto the printing target W′.

In step S313 following step S312, the XYθ processing unit 131 converts the XY coordinates again based on the Z misalignment detected in step S312. This re-conversion considers both the XY misalignment detected by pattern search and the XY directional position deviation caused by the height of the printing target W′.

This enables accurate correction of XY misalignment of the printing target W′, allowing the desired printing pattern Pm to be formed at the desired position on the printing target W′.

Then, in step S314 following step S313, the printing controller 100 determines whether height measurement has been completed for all distance measurement positions I. If the determination is YES, it proceeds to step S315, while if NO, it returns to step S308.

In step S315, the XYθ processing unit 131 and Z processing unit 132 correct the emission position of the printing laser light in the XYZ direction. In this step S315, both the correction of the position and orientation in the XY direction considering the influence of the height of the workpiece W, and the correction of the position and orientation in the Z direction (correction of the focal position) based on the height of the workpiece W are taken into account.

Thus, the pre-printing process based on the workflow Wf exemplified in FIG. 21 is completed. Subsequently, it proceeds to step S33 in FIG. 7 from FIG. 24, and the printing controller 100 executes the printing process.

Since the position and orientation deviations in the XYZ directions have already been corrected, the head control unit 102 can perform two-dimensional scanning while considering the effects of XY misalignment and Z misalignment. When performing tilt correction for height correction, height measurements are executed for at least three distance measurement positions I. In this case, in the aforementioned step S315, a correction (tilt correction) to cancel out the tilt is executed. This tilt correction can be executed using, for example, trapezoidal correction of the captured image Pw′.

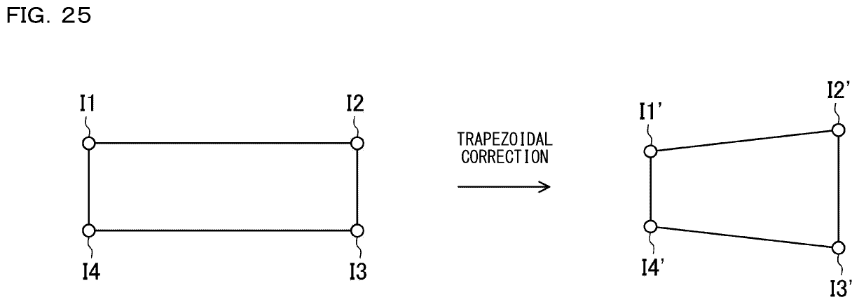

For example, as shown in FIG. 25, height measurements are taken at distance measurement positions I1, I2, I3, and I4, and based on these measurement results, trapezoidal correction can be performed using the distance measurement positions I1 to I4 as the four corners. In this case, the distance measurement positions I1, I2, I3, and I4 are converted to corrected positions I1′, I2′, I3′, and I4′, respectively.

In the case of image discrimination, the processes of step S306, step S313, and step S315 become unnecessary. In the case of height detection, step S312 and step S315 become unnecessary. The process of step S315 is effective in ensuring various accuracies such as printing accuracy, for example, when both position correction and height detection are set to be performed.

### 7. Relationship Between Position Correction and Focal Length

Incidentally, two-dimensional position correction such as XYθ correction may potentially decrease printing accuracy when the printing target is a workpiece W with height.

For example, the focal position of the printing laser light differs between the central area and the edge area of the printing region R1 set on the workpiece W when two-dimensionally scanned by the laser light scanner 4. Specifically, as it moves from the center to the edge of the printing region R1, the focal position becomes separated from the printing region R1. Therefore, with position correction on a two-dimensional plane, there is a possibility that the focal position deviates after the correction. This is inconvenient for maintaining high printing accuracy.

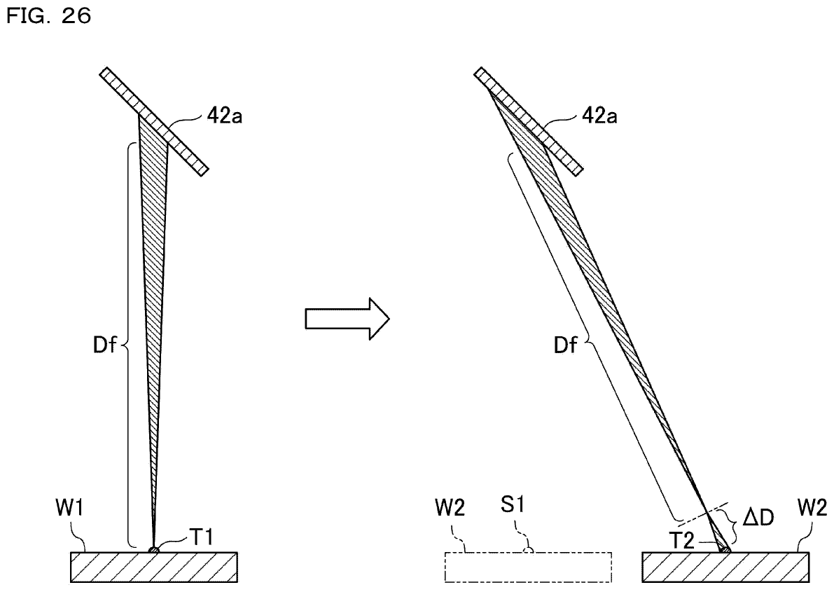

For example, as illustrated in FIG. 26, consider a case where printing laser light is irradiated on a first workpiece W1 with an optimized focal position Df, and a second workpiece W2 that is position-deviated in the XY direction relative to the first workpiece W1.

Here, assuming that as a result of correcting the position deviation in the XY direction for the second workpiece W2, the irradiation position of the printing laser light has moved from T1 to T2, the focal position Df that was optimized for the first workpiece W1 will be deviated by ΔD from the surface of the second workpiece W2. If the focal position is deviated, it is inconvenient for maintaining high printing accuracy.

In contrast, according to this embodiment, the laser marking apparatus L can detect the position deviation of the workpiece W′ in the XY direction through the XYθ processing unit 131, as exemplified in step S306 of FIG. 23, and correct the distance measurement position I based on the detection result. Then, as exemplified in step S312 of FIG. 24, the laser marking apparatus L corrects the focal position based on the measurement result by the distance measuring unit 103, with the distance measurement position I corrected by the XYθ processing unit 131, prior to irradiating the workpiece W′ with laser light.

By configuring the system to adjust the focal position after the position deviation of the workpiece W′ has been corrected, it is possible to maintain high printing accuracy even when the workpiece W′ has deviated from its position.

### 8. Processing Related to Workflow

As explained above, the workflow editor 304c of this embodiment edits a workflow Wf that defines a series of processes including printing process based on user input, as exemplified in FIGS. 17, 20, and 21. During this editing, as shown in FIGS. 8, 20, and 21, the workflow editor 304c adds the pre-post printing processes, which the input receiver 304g has accepted selection of, to the workflow Wf in an order according to the order information Io stored in advance.

By configuring in this way, it becomes possible to appropriately set a workflow Wf that defines the execution order of each process without requiring knowledge about the roles of each process, and to execute each process according to that setting. Additionally, even for users who have knowledge about the roles of each process, it becomes possible to quickly set the workflow Wf without making sequential judgments based on such knowledge. Therefore, the configuration related to the aforementioned embodiment can improve the user convenience of the laser marking apparatus L.

Also, as exemplified in FIG. 8, the pre-printing process related to the aforementioned embodiment may include numerous processes combining the imaging unit 62, 7 and the distance measuring unit 5. Having the user themselves set the execution order of such processes is inconvenient from the perspective of user convenience.

In contrast, the laser marking apparatus L can execute each process in an appropriate order regardless of the user's knowledge, even in cases where the pre-printing process may include numerous processes, thereby contributing to the improvement of user convenience.

As explained with reference to FIG. 8, FIG. 12, and FIG. 21, etc., XYθ correction and image discrimination have many overlapping setting items and processes, and it is considered that situations where they are used in combination essentially do not exist. While XYθ performs more advanced processes such as correction of printing data, as exemplified in FIG. 21, there are setting items that require prior knowledge, so it is not necessarily user-friendly for unfamiliar users. Image discrimination, although it does not perform processes as advanced as XYθ correction, can be easily utilized even by unfamiliar users.

Therefore, the workflow editor 304c according to the aforementioned embodiment, as exemplified in the third column of FIG. 8 and steps S134 and S135 of FIG. 17, adds only one of the processes that are not expected to be used in combination to the workflow Wf. As a result, it becomes possible to create a more appropriate workflow Wf.

Furthermore, as explained with reference to FIG. 8 and FIG. 22, height correction and height detection have many overlapping setting items and processes, and it is considered that situations where they are used in combination essentially do not exist. While height correction executes more advanced processes such as correction of printing data, as exemplified in FIG. 22, it has setting items that require prior knowledge, making it not necessarily user-friendly for unfamiliar users. Height detection, although not executing processes as advanced as height correction, can be easily utilized even by unfamiliar users.

Therefore, the workflow editor 304c according to the aforementioned embodiment, as exemplified in the third column of FIG. 8 and steps S134 and S135 of FIG. 17, adds only one of the processes that are not expected to be used in combination to the workflow Wf. As a result, it becomes possible to create a more appropriate workflow Wf.

Furthermore, as exemplified in the order information Io in FIG. 8 and the display examples in FIG. 19 and FIG. 20, the laser marking apparatus L determines the position and orientation of the workpiece W through XYθ correction or image discrimination, and then executes height correction or height detection after the determination result. By executing each process in this order, it becomes possible to adjust the distance measurement position I according to the position and orientation of the workpiece W. This enables the use of a more appropriate distance measurement position I.

Furthermore, as exemplified in FIG. 12, FIG. 23, FIG. 24, and FIG. 26, when configured to perform height correction following XYθ correction, it becomes possible to correct the focal position based on the measurement results for the corrected distance measurement position I′ in a state where the distance measurement position I has been corrected utilizing the execution results of the XYθ correction. This enables adjustment of the focal position after correcting the distance measurement position I considering the position deviation of the printing target W′, allowing for the maintenance of high printing accuracy even when the printing target W′ has deviated in position.

Setting a workflow Wf that reflects such processing order is not necessarily easy. However, by configuring the system to automatically arrange the execution order according to the order information Io as in this embodiment, user convenience can be improved.

Furthermore, as exemplified in FIG. 8, the window inspection as a maintenance process involves the control of the distance measuring unit 5. Therefore, it is considered that there exists an appropriate execution order for the aforementioned first to fourth pre-printing processes. However, for unfamiliar users, setting the appropriate execution order is not easy.

In contrast, according to this embodiment, the order information Io is defined to include the execution order of window inspection, as exemplified in FIG. 8. This enables the execution order of window inspection to be automatically defined when editing the workflow Wf, contributing to improved user convenience.

Furthermore, as explained using FIG. 15, when contamination adheres to the transparent member 19a, the light receiving part 52, which should originally receive only the distance measuring light reflected by the workpiece W, receives the distance measuring light reflected by the transparent member 19a instead of, or in addition to, this distance measuring light.

Here, the distance to the transparent member 19a does not vary regardless of the type of workpiece W. Therefore, the light receiving position caused by contamination of the transparent member 19a can be estimated in advance.

Therefore, for example, by considering the location of each light receiving position, the window inspection unit 151 can identify the distance measuring light caused by the reflected light from the transparent member 19a among the distance measuring light received by the light receiving unit 52. Thereby, the window inspection unit 151 becomes capable of detecting contamination on the transparent member 19a.

Contamination of the transparent member 19a is inconvenient for processes that require the passage of distance measuring light, imaging light, etc. through the transparent member 19a, such as the first to fourth pre-printing processes. Therefore, by configuring the window inspection to be performed before the aforementioned first to fourth pre-printing processes, it becomes possible to stop the operation of the laser marking apparatus L earlier when abnormalities or signs of abnormalities are observed in the maintenance information. This is advantageous for improving user convenience. This advantage becomes especially significant when the window inspection is configured to be performed before all of the first pre-printing process, second pre-printing process, third pre-printing process, and fourth pre-printing process.

Window inspection as a maintenance process corresponds to a process for inspecting the state of the laser marking apparatus L itself, and therefore can be performed smoothly even when the workpiece W after printing is in a state separated from the laser marking apparatus L. On the other hand, the print verification process and imaging process as inspection processes require imaging of the workpiece W, and thus can no longer be performed if the workpiece W after printing has moved away from the laser marking apparatus L. Therefore, it is convenient to perform the window inspection after the print verification process and imaging process.

On the other hand, for users unfamiliar with window inspection, it is not necessarily easy to set the window inspection to be performed after the printing confirmation process and the imaging process.

In contrast, as exemplified in FIG. 8, by defining the order information Io such that the window inspection is executed after the printing confirmation process and the imaging process, even an unfamiliar user can construct a more appropriate workflow Wf. This advantageously improves user convenience.

As exemplified in FIG. 18, FIG. 19, and FIG. 20, the display unit 301 independently displays a flow display area Rf1 and a flow selection area Rf2. This configuration has excellent visibility and contributes to improving user convenience.

Also, as illustrated in FIG. 21 and FIG. 22, by using the fourth interface If4 as a switching section, it is possible to individually turn on and off each process constituting the workflow Wf without changing the structure of the workflow Wf itself each time. This is advantageous in improving user convenience.

### Other Embodiments

In the aforementioned embodiment, the XYθ processing unit 131 was configured to use the captured image Pw cut out from the pattern area Rp, that is, the pattern image Pp, as the image information within the pattern area Rp. However, this disclosure is not limited to this configuration. The region setting unit 304e can also use edge information (for example, edge information based on brightness values) of the captured image Pw within the pattern area Rp as the image information within the pattern area Rp. In addition, shape information such as the outline of the object, color information, texture information, etc. may be used as the image information within the pattern area Rp.

Furthermore, the optical system configuration shown in FIG. 2 is merely an example. For instance, regarding the printing area inspection unit 6, the guide optical axis A2 of the guide light source 61 may be branched from the upstream laser optical axis A11. Similarly, the first imaging optical axis A4 of the coaxial camera 62 and the distance measuring optical axis A3 of the distance measuring unit 5 can be branched from a midway point of the laser optical axis A1 connecting the laser light generator 2 and the laser light scanner 4.

### DESCRIPTION OF REFERENCE NUMERALS

[symbol]

What is claimed is:

1. A laser marking apparatus comprising:
a laser light generator that generates laser light to be irradiated onto a marking area of a workpiece;
a laser light scanner that two-dimensionally scans the laser light generated by the laser light generator within the marking area;
an imaging unit that captures an image of the workpiece to obtain a captured image;
a distance detector that outputs a detection signal indicating the distance to a distance measurement position indicating a position for measuring the distance on the surface of the workpiece;
a controller that executes a marking process to form a predetermined marking pattern within the marking area by controlling the laser light generator and the laser light scanner, and executes a pre-post marking process consisting of at least one of a pre-marking process that obtains information related to at least one of the position and orientation of the workpiece before executing the marking process by controlling at least one of the imaging unit and the distance detector, and a post-marking process that obtains information related to the marking pattern formed by the marking process after executing the marking process by controlling at least one of the imaging unit and the distance detector;
wherein the laser marking apparatus further comprises:
an order information storage that stores order information associated with each of the pre-post marking processes;
a trigger signal receiver that accepts input of a trigger signal for causing the controller to execute the marking process;
a workflow editor that edits a workflow defining a series of processes including the marking process to be executed by the controller from when the trigger signal is input to the trigger signal receiver until it is possible to accept input of the trigger signal again;
a display unit that displays the pre-post marking processes corresponding to and associated with the order information stored in the order information storage;
an input receiver that accepts selection of the pre-post marking processes to be included in the workflow in response to user input from among the pre-post marking processes displayed on the display unit;
wherein the workflow editor adds the pre-post marking processes for which selection has been accepted by the input receiver to the workflow including the marking process in an order according to the order information stored in the order information storage corresponding to said pre-post marking processes, and the controller executes the marking process and the pre-post marking processes in the order specified by the workflow to which the pre-post marking processes have been added by the workflow editor.

2. The laser marking apparatus according to claim 1, wherein the distance detector detects a light receiving position of distance measuring light that is emitted toward the distance measurement position through the laser light scanner and reflected at said distance measurement position, and outputs a detection signal indicating the distance to the distance measurement position based on said light receiving position.

3. The laser marking apparatus according to claim 2, wherein the display unit displays a setting surface corresponding to the printing area and displays the captured image generated by the imaging unit on the setting surface, further comprising:
a marking setting unit that sets the position and orientation of the printing pattern to be printed on the workpiece on the setting surface displayed on the display unit, a marking data generation unit that generates marking data corresponding to the printing pattern set by the marking setting unit,
a focal adjustment unit interposed between the laser light generator and the laser light scanner, which adjusts the focal position of the laser light generated by the laser light generator, wherein the pre-printing process includes one or more of:
a first pre-printing process that determines the position and orientation of the workpiece relative to the laser marking apparatus based on the captured image acquired through the imaging unit, and corrects the marking data so that the position and orientation of the printing pattern are corrected according to the position and orientation of the workpiece based on the determination result,
a second pre-printing process that determines the position and orientation of the workpiece relative to the laser marking apparatus based on the captured image acquired through the imaging unit, and decides the feasibility of the printing process on the workpiece based on the determination result,
a third pre-printing process that adjusts the focal position through the focal adjustment unit based on the distance to the distance measurement position acquired through the distance detector, a fourth pre-printing process that decides the feasibility of the printing process on the workpiece based on the distance to the distance measurement position acquired through the distance detector.

4. The laser marking apparatus according to claim 3, wherein when the input receiver accepts selection of both the first and second pre-printing processes, the workflow editor selectively adds either one of the first and second pre-printing processes to the workflow.

5. The laser marking apparatus according to claim 3,
wherein when the input receiver accepts selection of both the third pre-marking process and the fourth pre-marking process, the workflow editor selectively adds either one of the third pre-marking process and the fourth pre-marking process to the workflow.

6. The laser marking apparatus according to claim 3, wherein the order information is defined such that the first or second pre-printing process is executed before the third or fourth pre-printing process.

7. The laser marking apparatus according to claim 6, wherein when the workflow is defined such that the third pre-marking process is executed following the first pre-marking process, the controller corrects the distance measurement position based on the position and orientation of the workpiece determined by the first pre-marking process, and executes the third pre-marking process based on the corrected distance measurement position.

8. The laser marking apparatus according to claim 3, wherein at least one of the pre-printing process and the post-printing process further includes a maintenance process for acquiring maintenance information of the laser marking apparatus by the controller controlling the distance detector, and wherein the order information is defined to include an execution order of the maintenance process.

9. The laser marking apparatus according to claim 8, wherein
the distance detector comprises:
an emission unit that emits the distance measuring light toward the laser light scanner, and
a light receiving unit that receives, through the laser light scanner, the distance measuring light emitted from the emission unit and reflected by the workpiece,
the laser marking apparatus comprises:
a housing in which the laser light generator and the laser light scanner are incorporated,
a transparent member provided on the housing, through which the laser light two-dimensionally scanned by the laser light scanner passes,
a window inspection unit that detects and outputs contamination of the transparent member as the maintenance information by identifying, among the distance measuring light received by the light receiving unit, the distance measuring light caused by reflection from the transparent member,
the pre-printing process includes the maintenance process, and
the order information defines that the maintenance process is executed before the first to fourth pre-printing processes.

10. The laser marking apparatus according to claim 8, wherein the post-printing process includes: the maintenance process, and an inspection process for inspecting the workpiece on which the printing pattern has been printed by the printing process, based on the captured image acquired through the imaging unit, and the order information is defined such that the maintenance process is executed after the inspection process.

11. The laser marking apparatus according to claim 1, wherein the display unit displays: a flow display area that visualizes the structure of the workflow, reflecting the execution order of the pre-post printing processes with respect to the printing process, and a flow selection area that is displayed independently from the flow display area, lists the pre-post printing processes, and accepts user input for selecting the pre-post printing processes.

12. The laser marking apparatus according to claim 11, wherein:
the display unit displays a switching section for switching the execution possibility of each of the pre-post printing processes constituting the workflow in the workflow displayed in the flow display area, the input receiver accepts user input selecting the execution possibility through the switching section, and
the controller executes the printing process and the pre-post printing processes to reflect the user input through the switching section.
